(19) United States
(12) Patent Application Publication
(10) Pub. No.: US 2018/0099874 A1
(43) Pub. Date: Apr. 12, 2018

(54) HIERARCHICALLY POROUS ALUMINOSILICATE MATERIALS

(71) Applicant: Ohio State Innovation Foundation, Columbus, OH (US)

(72) Inventors: Prabir K. Dutta, Columbus, OH (US); Bo Wang, Xinxiang (CN)

(21) Appl. No.: 15/728,129

(22) Filed: Oct. 9, 2017

Related U.S. Application Data
(60) Provisional application No. 62/405,979, filed on Oct. 9, 2016.

(51) Int. Cl. C01B 39/46; C01B 39/20

(52) U.S. Cl. CPC C01B 39/46; C01B 39/20

(57) ABSTRACT

Disclosed are methods of synthesizing a hierarchically porous aluminosilicate materials. Methods for synthesizing a hierarchically porous aluminosilicate material can comprise (i) combining, in aqueous solution, a base, an aluminum source, and silicon source to form a precursor gel; (ii) removing water from the precursor gel to form a nucleated gel; and (iii) reacting the nucleated gel at a temperature of from 0° C. to 200° C. to form the hierarchically porous aluminosilicate material.

### CROSS REFERENCE TO RELATED APPLICATIONS

This application claims benefit of U.S. Provisional Patent Application No. 62/405,979, filed Oct. 9, 2016, which is hereby incorporated herein by reference in its entirety.

### BACKGROUND

Zeolites are used in numerous industrial applications as catalysts, ion-exchangers and molecular sieves. The superior performance is often related to the presence of well-defined micropores in the zeolite structure. However, in many cases the sole presence of micropores also imposes some limitations on their applicability.

It has been shown that by introduction of a mesopore system in some or all of the zeolite crystals improved performance can be obtained in a variety of applications. Conventional zeolites are typically polyhedral crystals of nano- to micron-size with molecular sized micropores throughout the crystal. In larger zeolite crystals, only the surface layer of zeolite is accessible for catalysis of bulky molecules, which are unable to fit into the molecular sized micropores. This leaves the interior of the zeolite crystal untouched. Hierarchically porous materials include both micropores and mesopores, or larger pores within the zeolite structure, which can enhance the transfer and chemistry of bulky molecules.

Reported synthesis methods of hierarchical zeolites include: bottom up, top down, dealumination and desiliconation. However, many synthetic methods include the use of templates to aid the formation of micropores and mesopores within the hierarchical zeolite structure. Many zeolite types, including MFI and zeolite β, require organic templates. Template-free synthesis of hierarchical zeolite, typically, refers to the hierarchical zeolite synthesis process, where the mesopores are formed without addition of templates.

Faujasite (FAU), one of the most studied type of zeolite, is used in catalysis, separation, and medical applications. Current industrial hierarchical FAU synthesis are mostly focused on top down methods, like steam treatment or acid/base treatments, but typically use templated methods. However, templated synthesis methods require an additional synthetic step: removal of template molecules after zeolite crystallization, typically by calcination. Improved methods for preparing aluminosilicate materials are thus needed.

### SUMMARY

Provided herein are methods of synthesizing a hierarchically porous aluminosilicate materials. Methods for synthesizing a hierarchically porous aluminosilicate material can comprise (i) combining, in aqueous solution, a base, an aluminum source, and silicon source to form a precursor gel; (ii) removing water from the precursor gel to form a nucleated gel; and (iii) reacting the nucleated gel at a temperature of from 0° C. to 200° C. to form the hierarchically porous aluminosilicate material.

The base, aluminum source, and silicon source can be combined in any suitable fashion to form the precursor gel. For example, step (i) can comprise adding the silicon source to an aqueous solution comprising the base and the aluminum source. The base can comprise an alkali metal hydroxide, such as NaOH. The aluminum source can comprise, for example, Al(OH)₃. The silicon source can comprise, for example, silica. The relative portions of the components forming the precursor gel can be varied to influence the composition and/or morphology of the resulting hierarchically porous aluminosilicate material. For example, in some embodiments, the molar ratio of silicon:aluminum in the precursor gel can be from 3 to 30 (e.g., from 5 to 15). In some embodiments, the molar ratio of sodium:aluminum in the precursor gel can be from 2 to 15 (e.g., from 2 to 10). In some embodiments, the molar ratio of water:aluminum in the precursor gel can be from 200 to 1000 (e.g., from 250 to 750). In certain embodiments, the precursor gel can comprise 8-8.5Na₂O:0.8-1.2Al₂O₃:6-7SiO₂:400-600H₂O. In particular embodiments, the precursor gel can comprise 8.3Na₂O:1Al₂O₃:6.4SiO₂:483.9H₂O.

In some cases, step (i) can further comprise aging the precursor gel. Aging the precursor gel can comprise incubating the precursor gel at room temperature for from one hour to two weeks (e.g., from one hour to one week, or from 2-72 hours).

Step (ii) can comprise removing an effective amount of water to induce nucleation, as determined by electron microscopy. The water can be removed using any suitable method. For example, in some embodiments, step (ii) can comprise heating the precursor gel to evaporate water from the precursor gel. By way of example, in some of these embodiments, the precursor gel can be heated to a temperature of at least 70° C. (e.g., to a temperature of from 70° C. to 120° C., or to a temperature of about 100° C.).

In some embodiments, step (ii) can comprise reducing the volume of the precursor gel by at least 20% (e.g., by at least 25%, by at least 30%, by at least 35%, by at least 40%, by at least 45%, by at least 50%, by at least 55%, by at least 60%, by at least 65%, or by at least 70%). In certain embodiments, step (ii) can comprise reducing the volume of the precursor gel by from 20% to 75% (e.g., from 40% to 75%, or from 40% to 60%).

In some embodiments, step (ii) can comprise reducing the volume of the precursor gel by at least 20% (e.g., by at least 25%, by at least 30%, by at least 35%, by at least 40%, by at least 45%, by at least 50%, by at least 55%, by at least 60%, by at least 65%, or by at least 70%) in one hour or less (e.g., 55 minutes or less, 50 minutes or less, 45 minutes or less, 40 minutes or less, 35 minutes or less, 30 minutes or less, 25 minutes or less, 20 minutes or less, or 15 minutes or less). In certain embodiments, step (ii) can comprise reducing the volume of the precursor gel by from 20% to 75% (e.g., from 40% to 75%, or from 40% to 60%) in one hour or less (e.g., 55 minutes or less, 50 minutes or less, 45 minutes or less, 40 minutes or less, 35 minutes or less, 30 minutes or less, 25 minutes or less, 20 minutes or less, or 15 minutes or less).

Step (iii) can comprise reacting the nucleated gel for a period of time effective for the hierarchically porous aluminosilicate material to exhibit a crystalline morphology, as determined by powder x-ray diffraction. In some cases, reacting the nucleated gel can comprise heating the nucleated gel. For example, reacting the nucleated gel can comprise heating the nucleated gel at a temperature of from 25° C. to 200° C. (e.g., from 70° C. to 120° C.).

In some cases, the hierarchically porous aluminosilicate material can comprise a zeolite. For example, in some cases, the zeolite can comprise a faujasite structure (e.g., the majority of the zeolite exhibits a faujasite structure). In some cases, the zeolite can comprise an EMT structure (e.g., the majority of the zeolite exhibits an EMT structure). In certain embodiments, the zeolite can comprise a mixture of faujasite and EMT.

The hierarchically porous aluminosilicate material can exhibit a silicon:aluminum ratio of at least 1 (e.g., a silicon:aluminum ratio of from 1 to 5). In some cases, methods for synthesizing a hierarchically porous aluminosilicate material can further comprise processing the hierarchically porous aluminosilicate material to increase the silicon:aluminum ratio (e.g., to increase the silicon:aluminum ratio to 5 or more).

In some cases, the hierarchically porous aluminosilicate material can exhibit an external surface area of from 50 m²/g to 300 m²/g (e.g., from 150 m²/g to 300 m²/g). In some cases, the hierarchically porous aluminosilicate material can exhibit a Type IV adsorption isotherm.

The hierarchically porous aluminosilicate material can be free of templating agents. For example, the hierarchically porous aluminosilicate material can be substantially free of zinc, lithium, organic compounds, or a combination thereof.

In some embodiments, the hierarchically porous aluminosilicate material can have an average particle size of from 100 nm to 500 nm (e.g., 150 nm to 500 nm), as measured by electron microscopy. In some embodiments, the hierarchically porous aluminosilicate material can be made up of particles having an average particle size of less than 100 nm (e.g., from 20 nm to 60 nm), as measured by electron microscopy. In some embodiments, the hierarchically porous aluminosilicate material can be made up of nanosheets having an average thickness of from 10 nm to 100 nm (e.g., from 20 nm to 60 nm), and an average length of from 100 nm and 500 nm (e.g., from 100 nm to 250 nm).

Also provided are hierarchically porous aluminosilicate materials prepared by the methods described herein. For example, provided herein are hierarchically porous aluminosilicate materials that comprise aluminum, silicon, and sodium ions, wherein, the molar ratio of sodium ions:aluminum is from 2 to 10 and the molar ratio of silicon:aluminum is from 2 to 15; wherein the hierarchically porous aluminosilicate material has a ratio of total volume to micropore volume of at least 1.5 (e.g., a ratio of total volume to micropore volume of from 1.5 to 5); and wherein the hierarchically porous aluminosilicate material exhibits an external surface area of from 50 m²/g to 300 m²/g (e.g., from 150 m²/g to 300 m²/g).

In some cases, the hierarchically porous aluminosilicate material can exhibit a Type IV adsorption isotherm. The hierarchically porous aluminosilicate material can be free of templating agents. For example, the hierarchically porous aluminosilicate material can be substantially free of zinc, lithium, organic compounds, or a combination thereof.

In some embodiments, the hierarchically porous aluminosilicate material can have an average particle size of from 100 nm to 500 nm (e.g., 150 nm to 500 nm), as measured by electron microscopy. In some embodiments, the hierarchically porous aluminosilicate material can be made up of particles having an average particle size of less than 100 nm (e.g., from 20 nm to 60 nm), as measured by electron microscopy. In some embodiments, the hierarchically porous aluminosilicate material can be made up of nanosheets having an average thickness of from 10 nm to 100 nm (e.g., from 20 nm to 60 nm), and an average length of from 100 nm and 500 nm (e.g., from 100 nm to 250 nm).

### DESCRIPTION OF DRAWINGS

FIG. 1 is a schematic illustration of the reactor used to prepare the CG (stopcock between the round bottom flask and funnel is turned to the “closed” or “off” position) and the RG (stopcock between the round bottom flask and funnel is turned to the “open” or “on” position).

FIG. 2 shows high resolution XRD pattern deconvolution of the EMT peak at 2θ 5.8° (panel a) and the FAU peak at 2θ 6.1° (panel b).

FIG. 3 shows calibration curves between the mass percentage and the GC peak areas of (panel a) benzene, (panel b) cumene, (panel c) 1,3-diisopropylbenzene, (panel d) 1,4-diisopropylbenzene, and (panel e) 1,3,5-triisopropylbenzene.

FIG. 4 is a schematic illustration of the various gel materials used to prepare the porous materials described herein.

FIG. 5 is a schematic illustration of the synthesis experiments performed using the CG to prepare the porous materials described herein.

FIG. 6 includes TEM images of (panel a) RG and (panel b) CG₄₀ (insert: high magnification TEM image of CG₄₀) illustrating the morphology of gel particles.

FIG. 7 shows XRD patterns of (trace i) RG and (trace ii) CG₄₀.

FIG. 8 illustrates the characteristics of zeolites crystallized at 100° C., including XRD patterns of (panel a, trace i) RG-100C and (panel a, trace ii) CG₄₀-100C and SEM images of (panel b) RG-100C and (panel c) CG₄₀-100C.

FIG. 9 shows adsorption/desorption isotherms of RG-100C (panel a) and CG₄₀-100C (panel b).

FIG. 10 shows an XRD pattern (panel a) and SEM image (panel b) of CG₂₀-50C4d-100C.

FIG. 11 shows an adsorption/desorption isotherm of CG₂₀-50C4d-100C.

FIG. 12 shows the XRD patterns of CG₄₀-2C247d-100C (trace a); CG₄₀-25C72d-100C (trace b); CG₄₀-50C4d-100C (trace c); and CG₄₀-75C3d-100C (trace d) along with a high resolution XRD scan in the range of 2θ 5-7° in the inserts.

FIG. 13 shows adsorption/desorption isotherms of (panel a) CG₄₀-2C247d-100C; (panel b) CG₄₀-25C72d-100C; (panel c) CG₄₀-50C4d-100C; and (panel d) CG₄₀-75C3d-100C.

FIG. 14 shows the results of pore size distribution analysis using BJH method of (panel a) CG₄₀-2C247d-100C; (panel b) CG₄₀-25C72d-100C; (panel c) CG₄₀-50C4d-100C; and (panel d) CG₄₀-75C3d-100C.

FIG. 15 shows the results of pore size distribution analysis using NLDFT method of (panel a) CG₄₀-2C247d-100C; (panel b) CG₄₀-25C72d-100C; (panel c) CG₄₀-50C4d-100C; and (panel d) CG₄₀-75C3d-100C.

FIG. 16 shows TEM images of (panel a) CG₄₀-2C247d-100C; (panel b) CG₄₀-25C72d-100C; (panel c) CG₄₀-50C4d-100C; and (panel d) CG₄₀-75C3d-100C.

FIG. 17 shows the estimation of FAU sheet thickness from TEM images of (panel a) CG₄₀-2C247d-100C; (panel b) CG₄₀-25C72d-100C; (panel c) CG₄₀-50C4d-100C; and (panel d) CG₄₀-75C3d-100C.

FIG. 18 shows the (panel a) XRD pattern; (panel b) TEM image; (panel c) adsorption/desorption isotherm; and (panel d) pore size distribution analysis (BJH) of CG₆₀-50C10d-100C.

FIG. 19 shows the characteristics of materials obtained during CG₄₀-50C reaction (panel a) XRD patterns of (trace i) CG₄₀-50C1d; (trace ii) CG₄₀-50C2d; (trace iii) CG₄₀-50C3d; (trace iv) CG₄₀-50C4d; and (trace v) CG₄₀-50C4d-100C; (panel b) SEM images and (panel c) TEM images of (i) CG₄₀-50C1d; (ii) CG₄₀-50C2d; (iii) CG₄₀-50C3d; (iv) CG₄₀-50C4d and (v) CG₄₀-50C4d-100C.

FIG. 20 shows high resolution electron microscopy images of CG₄₀-50C4d-100C (panel a) low magnification TEM image on multiple particles; (panel b) SEM images of one particle with Focused Ion Beam (FIB) cut; high resolution TEM images of (panel c) nanosheets packing; (panel d) entire particle; (panel e) nanosheet only; and (panel f) showing an example of a FAU/EMT intergrowth (inserts: corresponding FFT of the TEM images).

FIG. 21 shows the XRD pattern of CG₄₀-50C4d-100C with (trace i) thermal treatment at 600° C. for 24 hours and (trace ii) acid form of CG₄₀-50C4d-100C (prepared by NH₄⁺ exchange followed by calcination) at 550° C. with 100% relative humidity for 24 hours.

FIG. 22 illustrates the thermal stability of CG₄₀-50C4d-100C. Panels a and b include SEM images and images of CG-50C4d-100C before (panel a) and after (panel b) calcination at 600° C. for 24 hours (no steam). Panels c and d include TEM images and images of CG-50C4d-100C before (panel c) and after (panel d) calcination at 600° C. for 24 hours (no steam).

FIG. 23 shows (panel a) aTEM image of acidic CG₄₀-50C4d-100C and (panel b) XRD patterns of (trace i) as-synthesized CG₄₀-50C4d-100C and (trace ii) acidic CG₄₀-50C4d-100C (no steam treatment in either case, just thermal treatment, and used for the 1,3,5 TIBP cracking reaction).

FIG. 24 is a bar graph illustrating a comparison of product distribution observed for the dealkylation of 1,3,5-triisopropylbenzene at 200, 300 and 400° C. for using RG-100C and CG₄₀-50C4d-100C as a catalyst (1,3-DiPBz: 1,3-Diisopropylbenzene; 1,4-DiPBz: 1,4-Diisopropylbenzene).

FIG. 25 is a picture of catalysts after catalysis experiments at 400° C. More extensive coking was observed in the RG sample.

FIG. 26 shows a TEM image of CG₄₀50C4d100C after sonication for 4 hours, which demonstrates the tight packing of the nanosheets.

FIG. 27 shows (panel a) an XRD pattern; (panel b) a TEM image; (panel c) an adsorption/desorption isotherm; and (panel d) a pore size distribution analysis (BJH) of CRG₄₀-50C1d-100C (40% of water removed right from start of synthesis).

FIG. 28 shows (panels a, d) an XRD pattern; (panels b, e) an adsorption/desorption isotherm; and (panels c, f) a pore size distribution analysis (BJH) of (panels a, b, c) CG₄₀-0.5h-50C4d-100C and (panels d, e, f) CG₄₀-2h-50C1d-100C.

### DETAILED DESCRIPTION

Provided herein are methods of synthesizing a hierarchically porous aluminosilicate materials. Methods for synthesizing a hierarchically porous aluminosilicate material can comprise (i) combining, in aqueous solution, a base, an aluminum source, and silicon source to form a precursor gel; (ii) removing water from the precursor gel to form a nucleated gel; and (iii) reacting the nucleated gel at a temperature of from 0° C. to 200° C. to form the hierarchically porous aluminosilicate material.

The base, aluminum source, and silicon source can be combined in any suitable fashion to form the precursor gel. For example, step (i) can comprise adding the silicon source to an aqueous solution comprising the base and the aluminum source. The base can comprise an alkali metal hydroxide, such as NaOH, KOH, or LiOH. The aluminum source can comprise, for example, Al(OH)₃. The silicon source can comprise, for example, silica.

The relative portions of the components forming the precursor gel can be varied to influence the composition and/or morphology of the resulting hierarchically porous aluminosilicate material.

In some embodiments, the molar ratio of silicon:aluminum in the precursor gel can be 3:1 or more (e.g., 4:1 or more, 5:1 or more, 6:1 or more, 7:1 or more, 8:1 or more. 9:1 or more, 10:1 or more, 11:1 or more, 12:1 or more, 13:1 or more, 14:1 or more, 15:1 or more, 16:1 or more, 17:1 or more, 18:1 or more, 19:1 or more, 20:1 or more, 21:1 or more, 22:1 or more, 23:1 or more, 24:1 or more, 25:1 or more, 26:1 or more, 27:1 or more, 28:1 or more, or 29:1 or more). In some embodiments, the molar ratio of silicon:aluminum in the precursor gel can be 30:1 or less (e.g., 29:1 or less, 28:1 or less, 27:1 or less, 26:1 or less, 25:1 or less, 24:1 or less, 23:1 or less, 22:1 or less, 21:1 or less, 20:1 or less, 19:1 or less, 18:1 or less, 17:1 or less, 16:1 or less, 15:1 or less, 14:1 or less, 13:1 or less, 12:1 or less, 11:1 or less, 10:1 or less, 9:1 or less, 8:1 or less, 7:1 or less, 6:1 or less, 5:1 or less, or 4:1 or less).

The molar ratio of silicon:aluminum can be from any of the minimum values described above to any of the maximum values described above. For example, the molar ratio of silicon:aluminum can be from 3:1 to 30:1 (e.g., from 3:1 to 19:1, from 4:1 to 20:1, from 5:1 to 15:1, from 5:1 to 12:1, or from 6:1 to 8:1).

In some embodiments, the molar ratio of sodium:aluminum in the precursor gel can be 2:1 or more (e.g., 3:1 or more, 4:1 or more, 5:1 or more, 6:1 or more, 7:1 or more, 8:1 or more. 9:1 or more, 10:1 or more, 11:1 or more, 12:1 or more, 13:1 or more, or 14:1 or more). In some embodiments, the molar ratio of silicon:aluminum in the precursor gel can be 15:1 or less (e.g., 14:1 or less, 13:1 or less, 12:1 or less, 11:1 or less, 10:1 or less, 9:1 or less, 8:1 or less, 7:1 or less, 6:1 or less, 5:1 or less, 4:1 or less, or 3:1 or less).

The molar ratio of sodium:aluminum can be from any of the minimum values described above to any of the maximum values described above. For example, the molar ratio of sodium:aluminum can be from 2:1 to 15:1 (e.g., from 2:1 to 10:1, from 3:1 to 10:1, or from 5:1 to 10:1).

In some embodiments, the molar ratio of water:aluminum in the precursor gel can be 200:1 or more (e.g., 250:1 or more, 300:1 or more, 400:1 or more, 500:1 or more, 600:1 or more, 700:1 or more, 750:1 or more, 800:1 or more, or 900:1 or more). In some embodiments, the molar ratio of water:aluminum in the precursor gel can be 1000:1 or less (e.g., 900:1 or less, 800:1 or less, 750:1 or less, 700:1 or less, 600:1 or less, 500:1 or less, 400:1 or less, 300:1 or less, or 250:1 or less).

The molar ratio of water:aluminum can range from any of the minimum values described above to any of the maximum values described above. For example, the molar ratio of water:aluminum can be from 200:1 to 1000:1 (e.g., from 250:1 to 750:1, from 300:1 to 900:1, from 400:1 to 1000:1, from 500:1 to 700:1, or from 600:1 to 800:1).

In certain embodiments, the precursor gel can comprise 8-8.5Na₂O:0.8-1.2Al₂O₃:6-7SiO₂:400-600H₂O. In particular embodiments, the precursor gel can comprise 8.3Na₂O:1Al₂O₃:6.4SiO₂:483.9H₂O.

In some cases, step (i) can further comprise aging the precursor gel. Aging the precursor gel can comprise incubating the precursor gel at room temperature for from one hour to two weeks (e.g., from one hour to one week, from 2-72 hours, from 2-60 hours, from 2-48 hours, from 2-36 hours, from 2-32 hours, from 2-28 hours, from 2-24 hours, from 2-20 hours, from 2-16 hours, from 2-12 hours, from 2-10 hours, from 2-8 hours, from 2-6 hours, from 1-72 hours, from 1-60 hours, from 1-48 hours, from 1-36 hours, from 1-32 hours, from 1-28 hours, from 1-24 hours, from 1-20 hours, from 1-16 hours, from 1-12 hours, from 1-10 hours, from 1-8 hours, from 1-6 hours, or from 1-4 hours). In certain embodiments, the precursor gel can be incubated at room temperature (e.g., at about 25° C.).

Step (ii) can comprise removing an effective amount of water to induce nucleation, as determined by electron microscopy. The water can be removed using any suitable method. For example, in some embodiments, step (ii) can comprise heating the precursor gel to evaporate water from the precursor gel. By way of example, in some of these embodiments, the precursor gel can be heated to a temperature of at least 70° C. (e.g., to a temperature of from 70° C. to 120° C., or to a temperature of about 100° C.).

In some embodiments, step (ii) can comprise reducing the volume of the precursor gel by at least 20% (e.g., by at least 25%, by at least 30%, by at least 35%, by at least 40%, by at least 45%, by at least 50%, by at least 55%, by at least 60%, by at least 65%, or by at least 70%). In certain embodiments, step (ii) can comprise reducing the volume of the precursor gel by from 20% to 75% (e.g., from 40% to 75%, or from 40% to 60%).

In some embodiments, step (ii) can comprise reducing the volume of the precursor gel by at least 20% (e.g., by at least 25%, by at least 30%, by at least 35%, by at least 40%, by at least 45%, by at least 50%, by at least 55%, by at least 60%, by at least 65%, or by at least 70%) in one hour or less (e.g., 55 minutes or less, 50 minutes or less, 45 minutes or less, 40 minutes or less, 35 minutes or less, 30 minutes or less, 25 minutes or less, 20 minutes or less, or 15 minutes or less). In certain embodiments, step (ii) can comprise reducing the volume of the precursor gel by from 20% to 75% (e.g., from 40% to 75%, or from 40% to 60%) in one hour or less (e.g., 55 minutes or less, 50 minutes or less, 45 minutes or less, 40 minutes or less, 35 minutes or less, 30 minutes or less, 25 minutes or less, 20 minutes or less, or 15 minutes or less).

Step (iii) can comprise reacting the nucleated gel for a period of time effective for the hierarchically porous aluminosilicate material to exhibit a crystalline morphology, as determined by powder x-ray diffraction. In some cases, reacting the nucleated gel can comprise heating the nucleated gel. For example, reacting the nucleated gel can comprise heating the nucleated gel at a temperature of from 25° C. to 200° C. (e.g., from 70° C. to 120° C.).

In some embodiments, the nucleated gel can be heated at a temperature of at least 25° C. (e.g., at least 30° C., at least 35° C., at least 40° C., at least 45° C., at least 50° C., at least 55° C., at least 60° C., at least 65° C., at least 70° C., at least 75° C., at least 80° C., at least 85° C., at least 90° C., at least 95° C., at least 100° C., at least 105° C., at least 110° C., at least 115° C., at least 120° C., at least 125° C., at least 130° C., at least 135° C., at least 140° C., at least 145° C., at least 150° C., at least 155° C., at least 160° C., at least 165° C., at least 170° C., at least 175° C., at least 180° C., at least 185° C., at least 190° C., or at least 195° C.). In some embodiments, the nucleated gel can be heated at a temperature of 200° C. or less (e.g., 195° C. or less, 190° C. or less, 185° C. or less, 180° C. or less, 175° C. or less, 170° C. or less, 165° C. or less, 160° C. or less, 155° C. or less, 150° C. or less, 145° C. or less, 140° C. or less, 135° C. or less, 130° C. or less, 125° C. or less, 120° C. or less, 115° C. or less, 110° C. or less, 105° C. or less, 100° C. or less, 95° C. or less, 90° C. or less, 85° C. or less, 80° C. or less, 75° C. or less, 70° C. or less, 65° C. or less, 60° C. or less, 55° C. or less, 50° C. or less, 45° C. or less, 40° C. or less, 35° C. or less, or 130° C. or less).

The nucleated gel can be heated to a temperature of from any of the minimum values described above to any of the maximum values described above. For example, reacting the nucleated gel can comprise heating the nucleated gel at a temperature of from 25° C. to 200° C. (e.g., from 30° C. to 190° C., from 50° C. to 150° C., or from 70° C. to 120° C.).

In some cases, the hierarchically porous aluminosilicate material can comprise a zeolite. For example, in some cases, the zeolite can comprise a faujasite structure (e.g., the majority of the zeolite exhibits a faujasite structure). In some cases, the zeolite can comprise an EMT structure (e.g., the majority of the zeolite exhibits an EMT structure). In certain embodiments, the zeolite can comprise a mixture of faujasite and EMT.

The hierarchically porous aluminosilicate material can exhibit a silicon:aluminum ratio of at least 1 (e.g., a silicon:aluminum ratio of from 1 to 5). In some cases, methods for synthesizing a hierarchically porous aluminosilicate material can further comprise processing the hierarchically porous aluminosilicate material to increase the silicon:aluminum ratio (e.g., to increase the silicon:aluminum ratio to 5 or more).

In some embodiments, the hierarchically porous aluminosilicate material can exhibit an external surface area of 50 m²/g or more (e.g., 75 m²/g or more, 100 m²/g or more, 125 m²/g or more, 150 m²/g or more, 175 m²/g or more, 200 m²/g or more, 225 m²/g or more, 250 m²/g or more, or 275 m²/g or more). In some embodiments, the hierarchically porous aluminosilicate material can have an external surface area of 300 m²/g or less (e.g., 275 m²/g or less, 250 m²/g or less, 225 m²/g or less, 200 m²/g or less, 175 m²/g or less, 150 m²/g or less, 125 m²/g or less, 100 m²/g or less, or 75 m²/g or less).

The hierarchically porous aluminosilicate material can have an external surface area of from any of the minimum values described above to any of the maximum values described above. In some cases, the hierarchically porous aluminosilicate material can exhibit an external surface area of from 50 m²/g to 300 m²/g (e.g., from 100 m²/g to 300 m²/g, from 50 m²/g to 250 m²/g, or from 100 m²/g to 250 m²/g). In some cases, the hierarchically porous aluminosilicate material can exhibit a Type IV adsorption isotherm.

The hierarchically porous aluminosilicate material can be substantially free of templating agents (e.g., the hierarchically porous aluminosilicate material can contain less than 1% by weight of templating agents, the hierarchically porous aluminosilicate material can contain less than 0.5% by weight of templating agents, or the hierarchically porous aluminosilicate material can contain less than 0.1% by weight of templating agents). For example, the hierarchically porous aluminosilicate material can be substantially free of zinc, lithium, organic compounds, or a combination thereof (e.g., the hierarchically porous aluminosilicate material can contain less than 1% by weight of zinc, lithium, organic compounds, or a combination thereof, the hierarchically porous aluminosilicate material can contain less than 0.5% by weight of zinc, lithium, organic compounds, or a combination thereof, or the hierarchically porous aluminosilicate material can contain less than 0.1% by weight of zinc, lithium, organic compounds, or a combination thereof).

In some embodiments, the hierarchically porous aluminosilicate material can have an average particle size of from 100 nm to 500 nm (e.g., 150 nm to 500 nm), as measured by electron microscopy. In some embodiments, the hierarchically porous aluminosilicate material can be made up of particles having an average particle size of less than 100 nm (e.g., from 20 nm to 60 nm), as measured by electron microscopy. In some embodiments, the hierarchically porous aluminosilicate material can be made up of nanosheets having an average thickness of from 10 nm to 100 nm (e.g., from 20 nm to 60 nm), and an average length of from 100 nm and 500 nm (e.g., from 100 nm to 250 nm).

Also provided are hierarchically porous aluminosilicate materials prepared by the methods described herein. For example, provided herein are hierarchically porous aluminosilicate materials that comprise aluminum, silicon, and sodium ions, wherein, the molar ratio of sodium ions:aluminum is from 2 to 10 and the molar ratio of silicon:aluminum is from 2 to 15; wherein the hierarchically porous aluminosilicate material has a ratio of total volume to micropore volume of at least 1.5 (e.g., a ratio of total volume to micropore volume of from 1.5 to 5); and wherein the hierarchically porous aluminosilicate material exhibits an external surface area of from 50 m²/g to 300 m²/g (e.g., from 150 m²/g to 300 m²/g).

In some cases, the hierarchically porous aluminosilicate material can exhibit a Type IV adsorption isotherm. The hierarchically porous aluminosilicate material can be free of templating agents. For example, the hierarchically porous aluminosilicate material can be substantially free of zinc, lithium, organic compounds, or a combination thereof.

In some embodiments, the hierarchically porous aluminosilicate material can have an average particle size of from 100 nm to 500 nm (e.g., 150 nm to 500 nm), as measured by electron microscopy. In some embodiments, the hierarchically porous aluminosilicate material can be made up of particles having an average particle size of less than 100 nm (e.g., from 20 nm to 60 nm), as measured by electron microscopy. In some embodiments, the hierarchically porous aluminosilicate material can be made up of nanosheets having an average thickness of from 10 nm to 100 nm (e.g., from 20 nm to 60 nm), and an average length of from 100 nm and 500 nm (e.g., from 100 nm to 250 nm).

By way of non-limiting illustration, examples of certain embodiments of the present disclosure are given below.

### Examples

Overview

A facile synthesis method of hierarchical faujasitic structures from a sodium aluminosilicate composition is described. The removal of water from the aluminosilicate gel during the synthesis process (e.g., via heating) was used to direct synthesis of the hierarchical faujasitic structure. These gels were used as starting materials for synthesis. With these partially dehydrated gels, extensive zeolite nucleation did occur, and the extent was varied both with the degree of dehydration and the temperature at which the dehydrated sample was maintained. Nanoparticles of FAU and EMT were formed that pack together resulting in external surface areas of 249-259 m²/g. In addition, under certain conditions of crystal growth, sheet like-structures arising from FAU-EMT intergrowths were observed. The interpenetration packing of the nanosheets lead to zeolitic particles with external surface areas in the range of 127-199 m²/g. The pore size distribution varied with sample preparation and ranged from 2-100 nm. These samples were characterized by N₂ adsorption, X-ray diffraction and electron microscopy. The thermal and hydrothermal stability was also studied. In order to evaluate the role of the higher external surface area on a chemical reaction, the dealkylation of 1,3,5-triisopropylbenzene was examined and the product distribution did reflect the mesoporous nature of the sample.

Background

Microporous crystalline zeolitic materials find applications in catalysis, separation, adsorption and ion exchange. Mass transfer limitations, inaccessibility of bulky molecules and coke formation are some of the drawbacks with reactions on conventionally prepared micropore zeolites. The combination of both micro- and mesopores leads to a hierarchical structure, where mesopores can enhance the reactivity of bulky molecules, followed by reactions within the micropores of the zeolite framework. Hierarchical structures favor novel product distributions. Synthesis of hierarchical zeolites is an active research area, with interest centered on the synthesis, characterization, and catalytic applications of these materials.

Mesopores in zeolites can be generated by using hard-template, soft-template, and template-free methods. Mesopores can also be generated by packing of nanoparticles, as well as selective twinning. Dealumination and desilication by post synthetic methods also generate mesoporosity, as do recrystallization methods. The majority of synthesis studies focus on organic-templates, and requires added steps to remove organics after zeolite synthesis by calcination.

Three-dimensional ordered mesoporous carbon has been used as hard template for confined growth of FAU. Cetyltrimethylammonium bromide has also been used to prepare FAU fragments. Organosilanes have been employed to generate mesoporosity. For example, 3-(trimethoxysilyl)propyl hexadecyl dimethyl ammonium chloride has been used to generate hierarchical zeolite X (Si/Al 1.2) with intergrowth of FAU nanosheets. Nanosheets of FAU in these studies has been shown to be a mixture of major FAU and EMT phases. A purely inorganic system using Li⁺ and Zn²⁺ in the aluminosilicate composition has also been reported to generate layer-like morphology of FAU structure.

Herein, a synthesis method of faujasitic-zeolite with both microporous and mesoporous nature from an 8.3 Na₂O:1 Al₂O₃:6.4 SiO₂:483.9 H₂O composition was developed. The synthesis strategy involves creating conditions for extensive zeolite nucleation by removing water during reflux of the gel. The concentrated gels were the subject of this study. Nutrient transport in these concentrated gels can be modified by temperature, or by viscosity (controlled by the extent of water removal). Specific conditions for growth of numerous nanocrystals, as well as nanosheets of FAU-EMT intergrowths were discovered. The particles can pack to form a zeolitic structure with both meso and microporosity. This growth process has been characterized by X-Ray diffraction, N₂ adsorption and electron microscopy. Reactivity of proton-exchanged forms of the zeolites for dealkylation of a bulky molecule, 1,3,5-triisopropylbenzene (1,3,5-TIPB) indicates the influence of the mesoporous structure

Methods and Materials

Chemicals

Aluminum hydroxide (Al(OH)₃, 76.5%) was purchased from Alfa Aesar. Ludox SM-30 colloidal silica (SiO₂, 30%) was bought from Sigma-Aldrich (Milwaukee, Wis., USA). Sodium hydroxide pellet (NaOH, 99.0%) was ordered from Fisher Scientific. All chemicals were used as received. H₂O used in this study was purified by a Millipore ultrapure water system.

Zeolite Synthesis Procedure Zeolite synthesis gel was prepared using standard methods known in the art, with a composition of 8.3 Na₂O:1 Al₂O₃:6.4 SiO₂:483.9 H₂O. Briefly, Al(OH)₃ (2.208 g) and 7.29 g NaOH were completely dissolved in 85.24 g H₂O, forming a clear solution. Then, 13.85 g Ludox SM-30 was slowly added into the solution, which turned opaque immediately. The opaque gel was then sealed in a polypropylene bottle with stirring for 4 hours at room temperature, resulting in the aged gel (AG). From AG, 2 types of gel were prepared: refluxed gel (RG) and concentrated gel (CG).

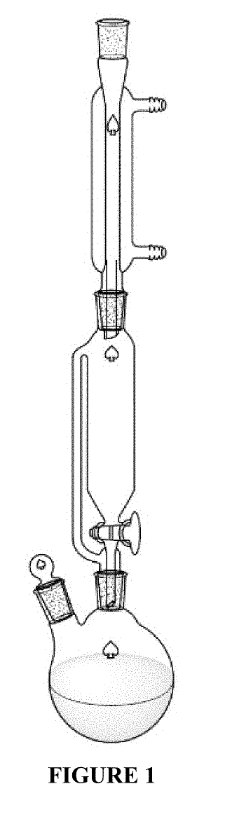

The reactor used to prepare both the CG and the RG is schematically illustrated in FIG. 1. As shown in FIG. 1, the reactor included a round bottom flask connected to a constant pressure funnel with condenser at the top. RG was prepared by heating AG for 1 hour with the switch of constant pressure funnel “on”, which is the reflux process. To prepare CG, AG was introduced into the same apparatus with the switch of constant pressure funnel “off” and heated to boiling, and evaporated water was collected in the funnel. Twenty, 40 and 60 mL of H₂O was removed from ˜100 mL of the gel in an hour, resulting in CG₂₀, CG₄₀ and CG₆₀.

RG and CG were then heated under different conditions. Synthesized zeolite powder product was washed with deionized water by repetitive centrifugation (2,500 rpm) until pH 7 and freeze dried.

Yield Calculation

Yield of zeolite samples were calculated as follows: In a typical batch, 100 mL AG was obtained after mixing all chemicals. From AG to CG₄₀, 40 mL of water was removed, and content of other chemicals were still the same. There was 2.208 g Al(OH)₃, 7.29 g NaOH and 4.16 g SiO₂ in 60 mL of CG₄₀. For a batch of 20 mL CG₄₀ which contains 4.6 g (SiO₂+Al₂O₃+NaOH), 1.6 g of zeolite product was obtained. So, the yield of zeolite was 35%. In a batch of 20 mL CG₄₀, there was 0.023 mol Si in the gel. Elemental analysis showed that about 65% of Si in the gel was incorporated in the zeolite framework and 35% of Si stayed in the supernatant (Si analysis on supernatant done by Galbraith Laboratories).

Zeolite Characterization

Bruker D8 Advance X-Ray Powder Diffractometer (XRD) was used to study the crystallinity of zeolite samples. Relative amounts of EMT and FAU were obtained from the high resolution XRD pattern (2θ from 5-7°) by calculating peak intensity with deconvolution and amount ratio using Reference Intensity Ratio (RIR). In this study, RIR values of 13.06 and 7.60 were used for FAU and EMT (relative to corundum), as obtained from PDF cards of 01-074-2394 and 00-046-0566, respectively. Calculation was done with software PDXL 2.0 from Rigaku. Equation used for calculation is shown below.

$$\frac{{x}_{FAU}}{{x}_{EMT}} = \frac{{I}_{FAU}}{{I}_{EMT}} \times \frac{{Ir}_{EMT}}{{Ir}_{FAU}} \times \frac{{RIR}_{EMT}}{{RIR}_{FAU}} \qquad ( 1 )$$

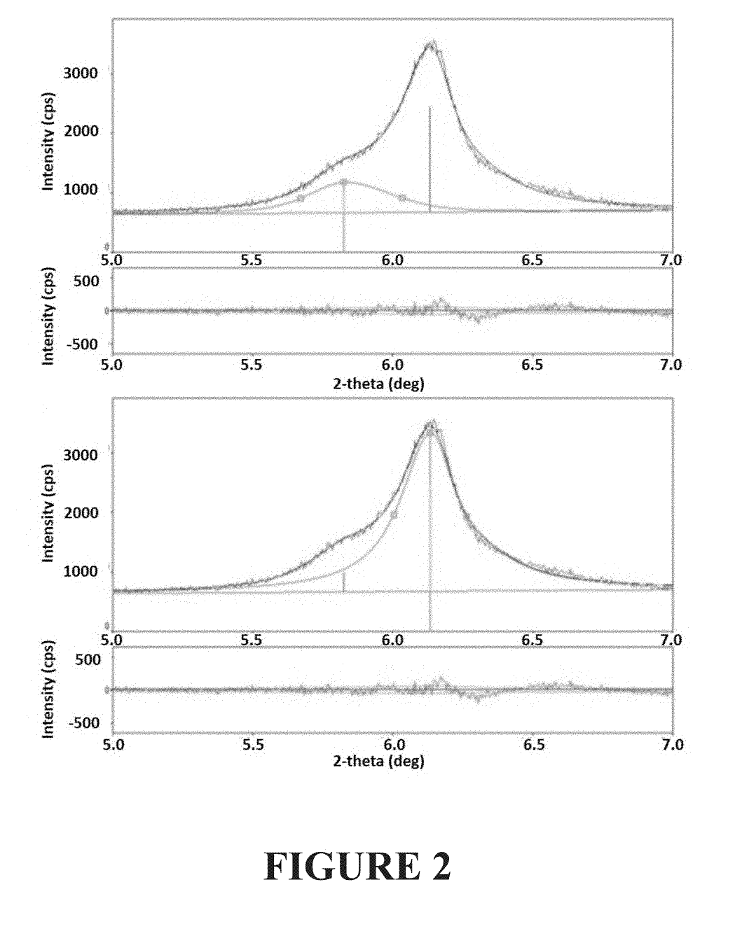

In equation (1), x is the relative mass of FAU and EMT; I is peak intensity obtained from XRD peak deconvolution (FIG. 2); Ir is the relative intensity of the chosen peak, and RIR values of FAU and EMT were obtained from the pdf files.

Si/Al ratio of zeolite samples was calculated from ²⁹Si Solid State Nuclear Magnetic Resonance (SSNMR) spectrum collected with Bruker 300 MHz DSX NMR equipped with a dual channel (H-X) MAS probe. Surface morphology of zeolite particles was studied with FEI Helios Nanolab 600 Scanning Electron Microscope (SEM). Particle morphology, crystallinity and composition analysis was obtained with FEI Probe Corrected Titan3™ 80-300 S/TEM.

N₂ Adsorption Isothermal Experiments and Calculations

Nova 2200e BET Surface Area Analyzer from Quantachrome was employed to collect the N₂ adsorption isotherm of zeolite samples. Surface area and pore size distribution was calculated with Brunauer-Emmett-Teller (BET) and Barrett-Joyner-Halenda (BJH) theories. T-plot method was applied in relative pressure (p/p₀) range of 0.21 to 0.42 to calculate external surface area and micro pore volume.

Before N₂ adsorption/desorption isotherm collection, zeolite samples were outgassed under vacuum at 400° C. for 24 hours. After cooling down to room temperature, a full isotherm was collected with 30 points in adsorption process and 17 points in desorption process.

BET surface area, external surface area, micropore volume and pore distributions were obtained from the isotherm. For microporous materials, like zeolites, a linear relationship between 1/[W(p/p₀)−1] and p/p₀ is expected in p/p₀ range of 0-0.05. External surface area of zeolite materials were calculated by the t-plot method, which is most suitable for oxide surfaces. In t-plot method, a t-plot was obtained from the isotherm using de Boer equation, which is most accurate in the range of p/p₀ 0.25-0.6. On the t-plot, a linear range was picked between 0.25-0.6 for external surface area calculation, (typically 0.2-0.42). Linear fitting in this range was employed to calculate external surface area (slope) and micropore volume (intercept). In this study, pore-size distribution analysis was obtained from each isotherm with 2 methods: Non-Linear Density Functional Theory (NLDFT) and Barrett-Joyner-Halenda (BJH). In NL-DFT method, full isotherm was employed for the calculation, while in BJH method, only desorption data was used. Detailed calculations of different methods employed in this study is found in the manual of Nova 2200e BET Surface Area Analyzer from Quantachrome.

1,3,5-TIPB Dealkylation

Catalytic performance of zeolites were studied with 1,3,5-TIPB dealkylation reaction. The acidic FAU was prepared by ion-exchanging zeolite samples with 0.2 M NH₄Cl solution for 1 h at 25° C., washing and calcination at 500° C. to eliminate the NH₃. 10 mg of acidic zeolite was placed in a gas phase downflow reactor catalysis setup shown in Figure S2.

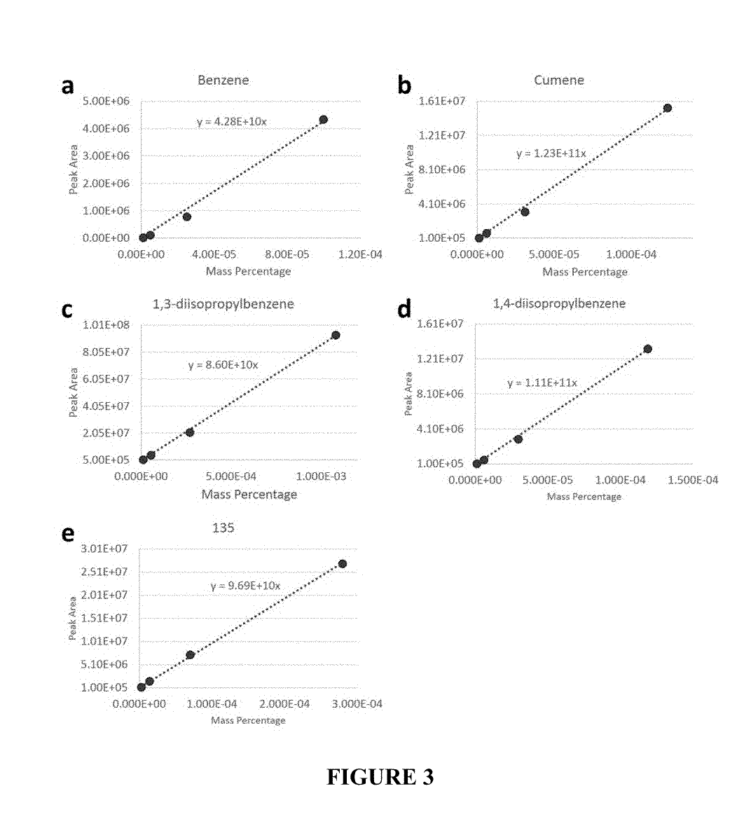

Initially, zeolite samples were dehydrated in dry air flow (50 mL/min) at 100° C. for 2 hours followed by 500° C. for 2 hours. Subsequently, dry nitrogen flow was applied (50 mL/min) and reactor temperature was dropped to the desired catalysis reaction temperature. Catalytic products as well as reactant samples were collected by bubbling through 40 mL dichloromethane and analyzed quantitatively with a Thermo DSQ II GC-MS system. Calibration curves of anticipated catalysis products (1,3-diisopropylbenzene, 1,4-diisopropylbenzene, cumene and benzene) are displayed in FIG. 3.

Catalysis product calculation was performed as follows. Peak areas of reactant and product samples were obtained from the GC. Based on the calibration curves, concentrations of each component in the dichloromethane solution was calculated. Yield of each anticipated products was calculated by weight percent over reactant (1,3,5-TIPB). Conversion was calculated by 1 minus the weight percent of unreacted 1,3,5-TIPB in product samples. Other components were calculated by subtracting 1 with all recognized components, 1,3,5-TIPB, 1,3-diisopropylbenzene, 1,4-diisopropylbenzene, cumene and benzene, and the rest was considered propylene, coke and unrecognized products.

Results

Synthesis Strategy

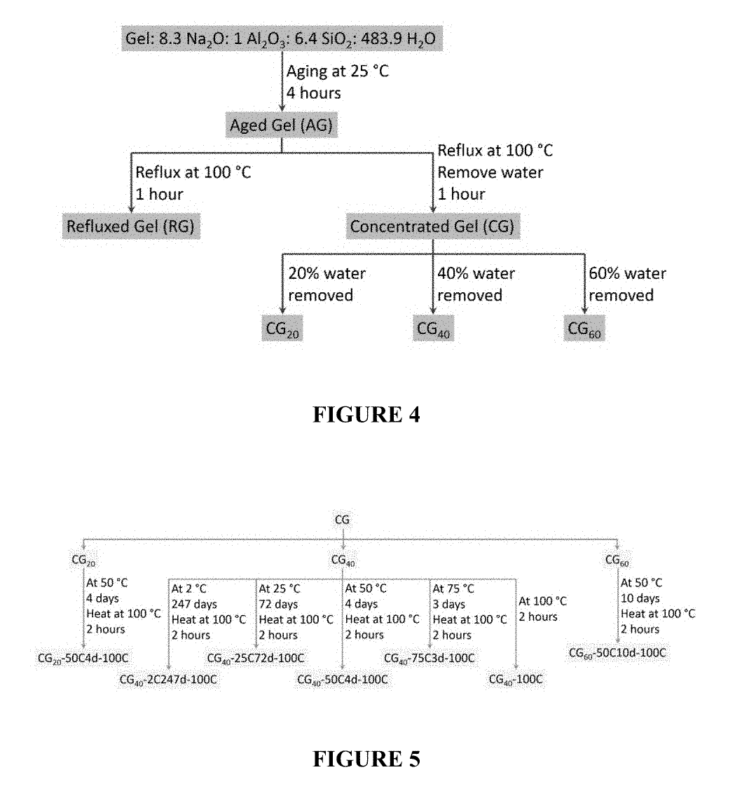

The basic synthesis strategy of this study is outlined in FIGS. 4 and 5. It involved the formation of
An opaque aluminosilicate gel by aging the composition 8.3 Na₂O:1 Al₂O₃:6.4 SiO₂: 483.9 H₂O for 4 hours at room temperature, resulting in a material labeled the aged gel (AG).
RG (refluxed gel) was prepared by heating AG under reflux for 1 hour in a round bottom flask connected with condenser (FIG. 1).
CG (concentrated gel) was prepared from AG by removing 20, 40 and 60% of the H₂O from the reaction composition during reflux, and labeled as CG₂₀, CG₄₀ and CG₆₀, respectively.

These gels had significant water still left in the composition and used as such for further experiments. As shown in FIG. 5, the CG gels were aged for different times at different temperatures until crystallization was complete (as monitored by XRD). A heat treatment step at 100° C. for 2 hours was carried out on all samples to ensure complete crystallization, and in most cases resulted in improvement of the specific surface area. Samples in this study were named with the following rule, “gel type”-“aging temperature and time”-“heating at 100° C. for 2 hours”.

Synthesis Results

Direct Heating of Gels

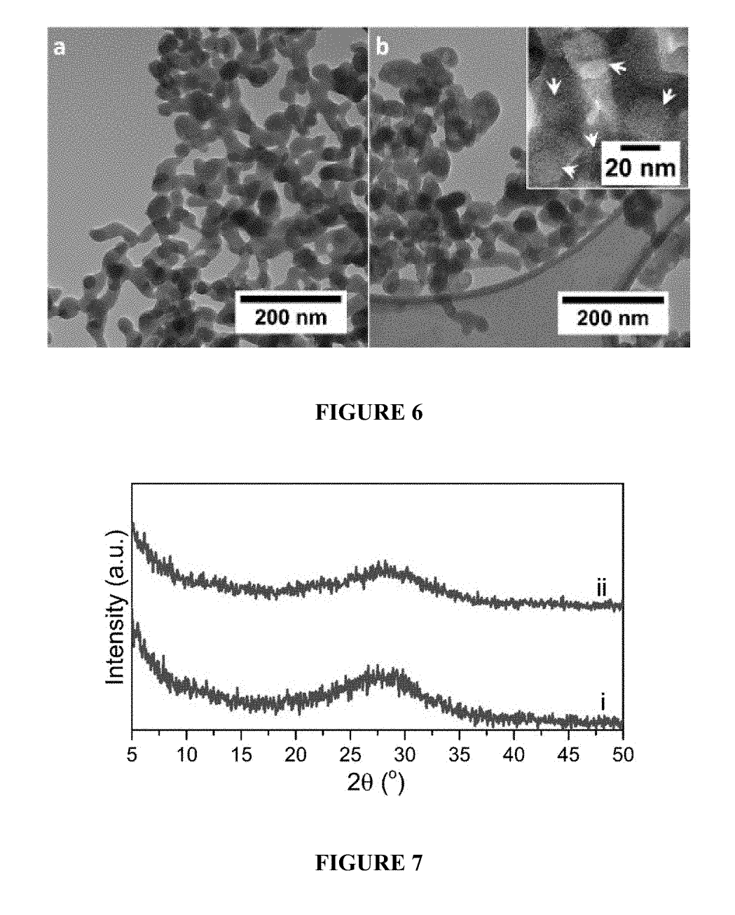

FIG. 6, panel a shows the TEM image of the as-synthesized RG, it has a coral-like structure. CG₄₀ has a similar coral-like morphology to RG, but with bright spots appearing on CG₄₀ as marked by arrows in FIG. 6, panel b (insert is a higher magnification TEM image). RG and CG₄₀ were both amorphous as characterized by XRD patterns (FIG. 7).

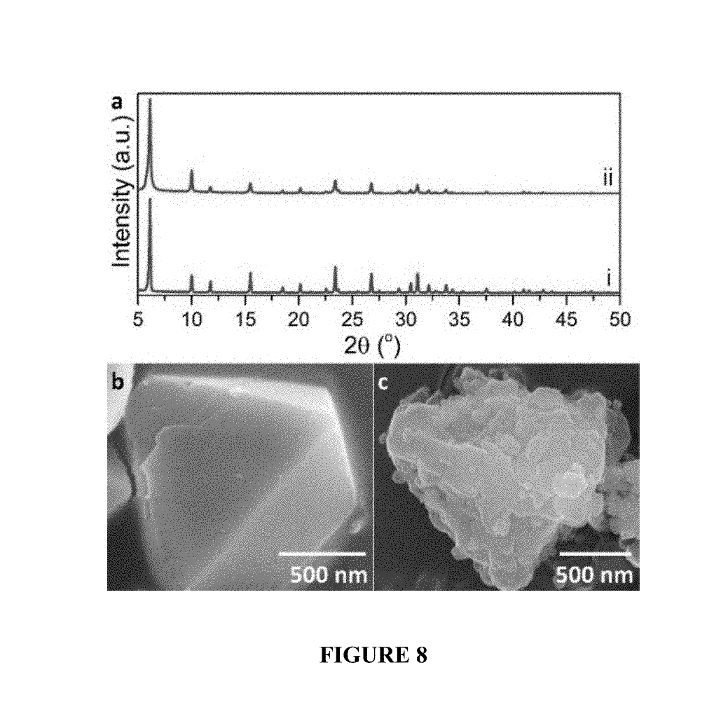

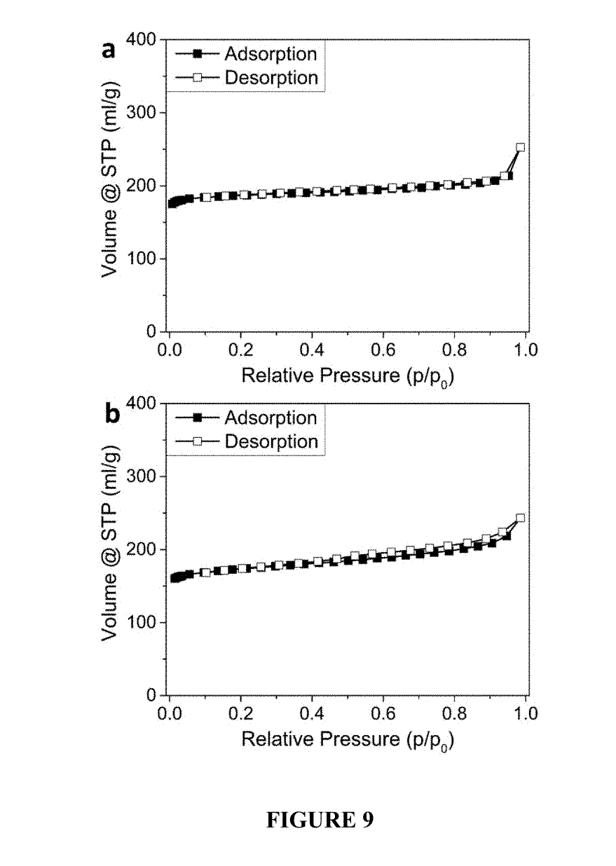

RG and CG₄₀ were sealed in a Teflon bottle and heated at 100° C. for 2 hours. XRD patterns are shown in FIG. 8 (panel a), only FAU peaks are observed. Particle morphologies of RG-100C and CG₄₀-100C are shown in FIG. 8 (panels b and c). RG-100C particles are single crystals with well-defined octahedral morphology, whereas CG₄₀ has similar overall morphology, but with clear steps on these surfaces. The N₂ adsorption/desorption isotherm of RG-100C shown in FIG. 9 is that of a Type I (microporous) material, whereas a slight hysteresis was observed with CG₄₀. Table 1 lists the equivalent specific surface area (measured by BET method, which includes the surface area of mesopores, micropores and the external surface), the external surface area (measured by t-plot method) and micropore volume (measured by t-plot method).

TABLE 1
N₂ adsorption characteristics of zeolite samples.

| | S_{BET} | S_{Ext} | V_{micro} |
|---|---|---|---|
| Sample | m²/g | m²/g | cm³/g |
| RG | 48 | 48 | — |
| RG-100C | 760 | 43 | 0.27 |
| CG₄₀ | 48 | 48 | — |
| CG₄₀-100C | 689 | 88 | 0.23 |
| CG₂₀-50C4d-100C | 789 | 63 | 0.28 |
| CG₄₀-2C247d-100C | 801 | 249 | 0.22 |
| CG₄₀-25C72d-100C | 849 | 199 | 0.26 |
| CG₄₀-50C4d-100C | 806 | 189 | 0.24 |
| CG₄₀-75C3d-100C | 756 | 127 | 0.24 |
| CG₆₀-50C10d-100C | 812 | 259 | 0.22 |
| CRG₄₀-50C1d-100C | 802 | 112 | 0.27 |
| CG₄₀-0.5h-50C4d-100C | 811 | 162 | 0.25 |
| CG₄₀-2h-50C1d-100C | 791 | 45 | 0.28 |
| Na⁺ exchanged thermal | 834 | 183 | 0.25 |
| stability | | | |
| CG₄₀-50C4d-100C | | | |
| H⁺ exchanged steam | 346 | 126 | 0.09 |
| treated | | | |
| CG₄₀-50C4d-100C | | | |

Aging of the Gels Followed by Heat Treatment

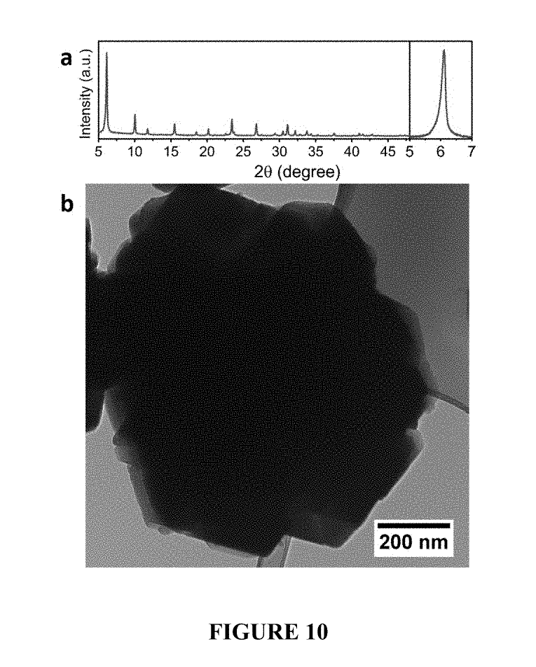

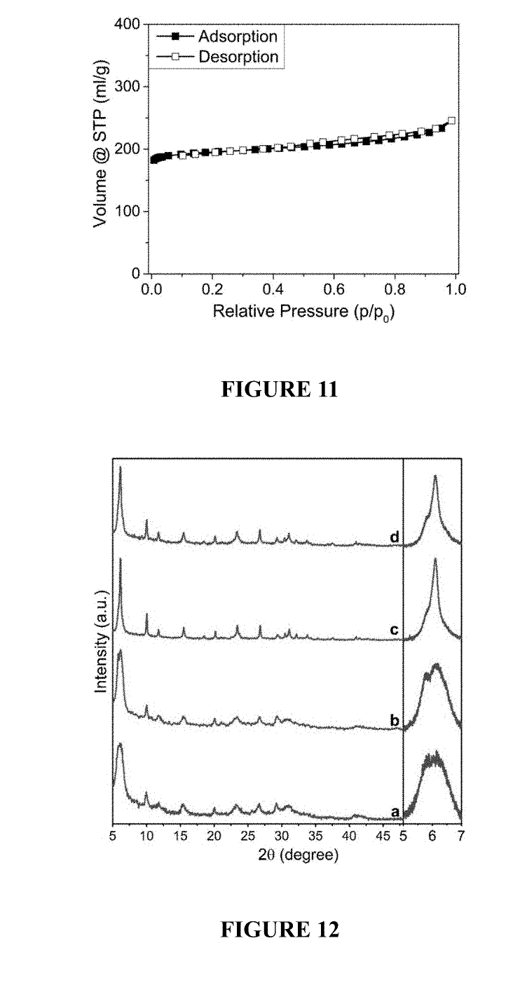

CG₂₀: The CG₂₀ sample was aged at 50° C. FIG. 10 shows the XRD and TEM images of CG₂₀-50C4d-100C sample. The choice of the aging time of 4 days at 50° C. was based on the time that crystallization appeared to be complete, based on the XRD. The XRD at earlier times are not being shown except for the CG₄₀ sample, which is presented below. FIG. 11 is the adsorption-desorption isotherm for CG₂₀-50C-4d100C, and appears to be a Type I isotherm, with a slight hysteresis (external surface area=63 m²/g).

CG₄₀: Four sets of samples were prepared with the CG₄₀ (FIG. 5), primarily involving aging at different temperatures. For the material aged at 2° C., it took 247 days for crystallization to be complete. With the 25° C. aging, it took 72 days; at 50° C., it took four days; and at 75° C., it took 3 days. All samples after the aging step were heated at 100° C. for 2 hours to ensure complete crystallization (FIG. 5).

FIG. 12 shows the XRD of the four CG₄₀ samples, and besides FAU, there was clear indication that EMT was also being formed (shoulder at 2θ=5.8°). In order to estimate the ratio of FAU to EMT, high resolution XRD was obtained in the 2θ region between 5-7° (data shown as inserts in FIG. 12). The FAU/EMT ratio was obtained by curve fitting with 29θ=5.8° and 6.1° for EMT and FAU, respectively. Relative amount of FAU and EMT were calculated as in equation (1) (an example is shown in FIG. 2). Table 2 shows these ratios, and EMT amounts increase at the lower temperatures of aging.

TABLE 2
FAU/EMT ratio of zeolite samples.

| | Relative Amount | |
|---|---|---|
| Sample | FAU | EMT |
| CG₂₀-50C4d-100C | >99 | <1 |
| CG₄₀-2C247d-100C | 84 | 16 |
| CG₄₀-25C72d-100C | 92 | 8 |
| CG₄₀-50C4d-100C | 93 | 7 |
| CG₄₀-75C3d-100C | 93 | 7 |
| CG₆₀-50C10d-100C | 8 | 92 |
| CRG₄₀-50C1d-100C | 95 | 5 |
| CG₄₀-0.5h-50C4d-100C | 86 | 14 |
| CG₄₀-2h-50C1d-100C | >99 | <1 |

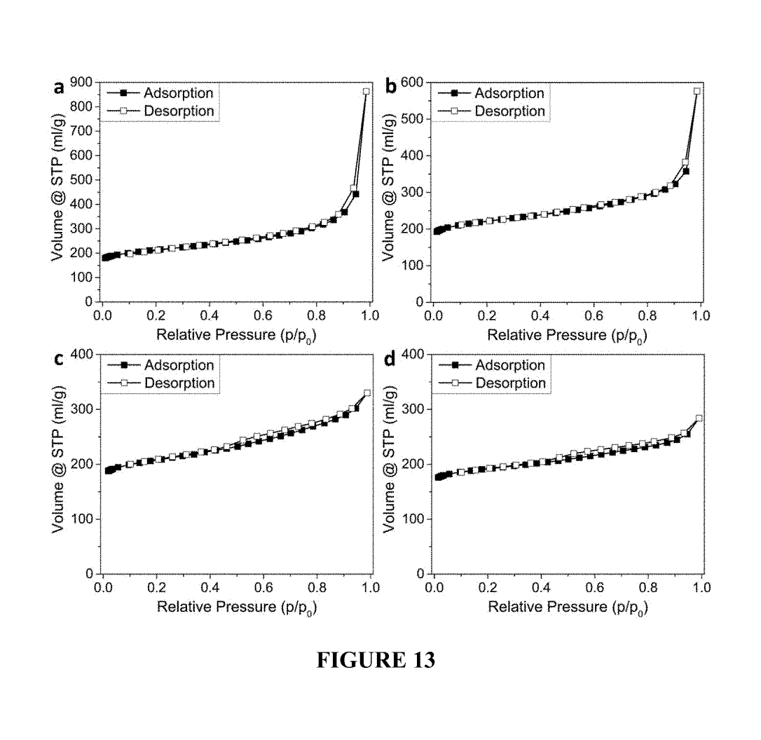

FIG. 13 shows the adsorption isotherms of the four CG₄₀ samples, and it is clear that the isotherms are a combination of Type I (microporous) and Type IV (mesoporous) adsorption. The external surface area is listed in Table 1. It appears that as the EMT amount is increasing, the mesoporosity is also exhibiting an increase (e.g. for CG₄₀-2C247d-100C, EMT=16%; Sₑₓₜ=249 m²/g).

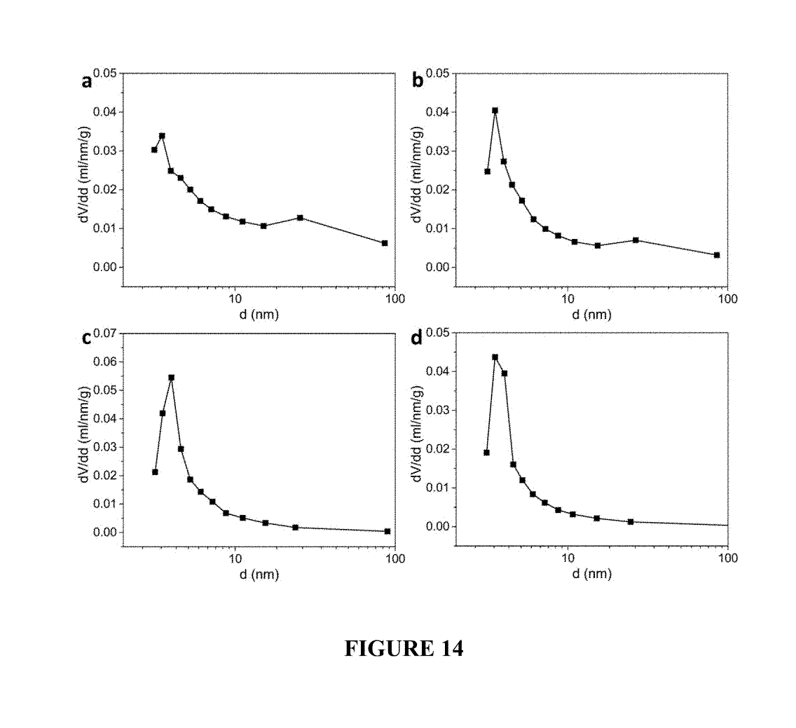

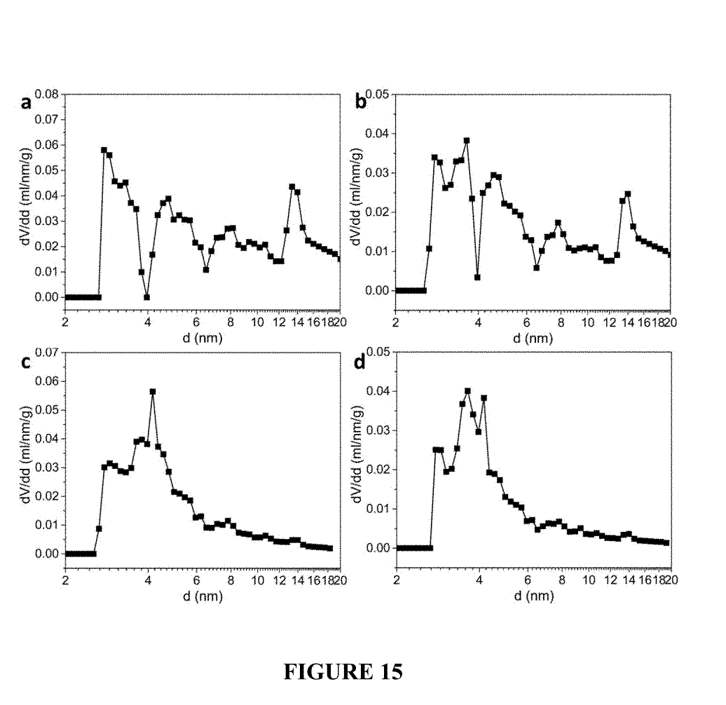

FIG. 14 shows the pore size distribution calculated by the BJH method, and FIG. 15 shows the pore size distribution calculated using NLDFT. They both indicate the same trends. As the aging temperature was lowered, there was a broader distribution of the pore size.

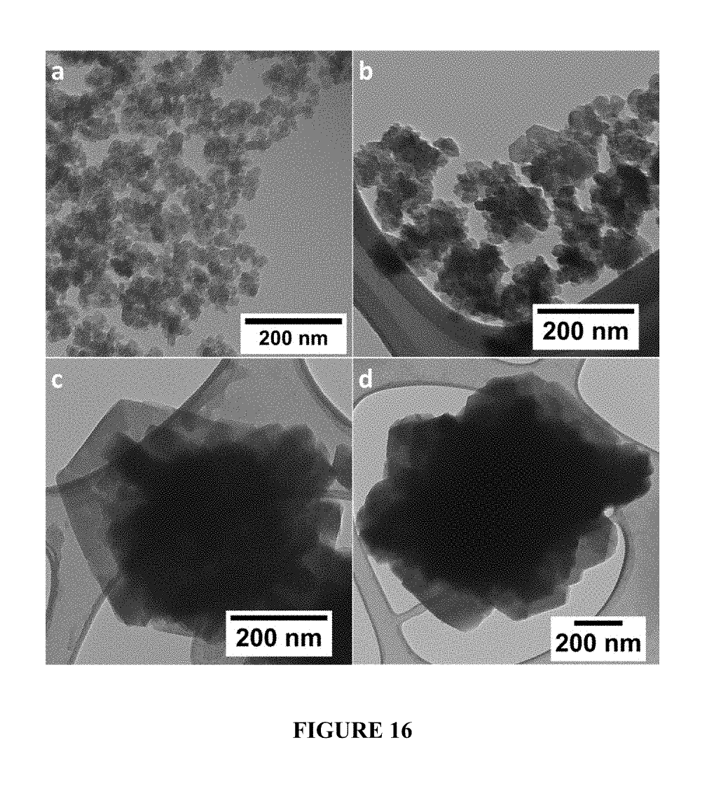

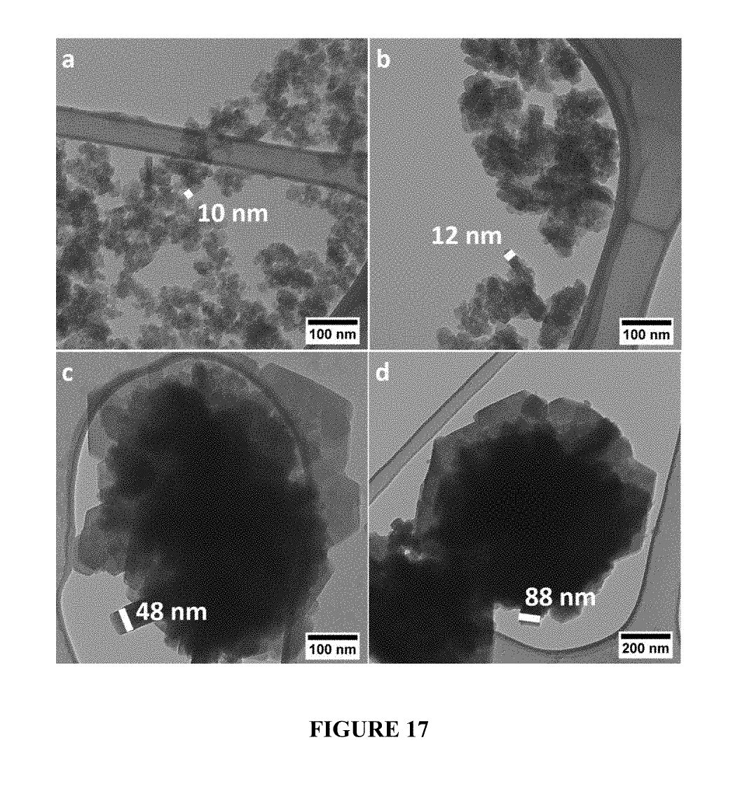

FIG. 16 shows the TEM of the four samples. The sizes estimated for CG₄₀-2C247d-100C CG₄₀-25C72d-100C, CG₄₀-50C4d-100C CG₄₀-75C3d-100C are 51, 105, 450 and 850 nm, respectively, indicating that particle size was decreasing as the temperature of aging was lowered. The thicknesses of the sheets estimated from the TEM images are ˜10 nm for the CG₄₀-2C247d-100C, 12 nm for CG₄₀-25C72d-100C, 48 nm for CG₄₀-50C4d-100C, and 88 nm for CG₄₀-75C3d-100C, respectively (FIG. 17 shows the TEM's from which the sheet thickness was estimated).

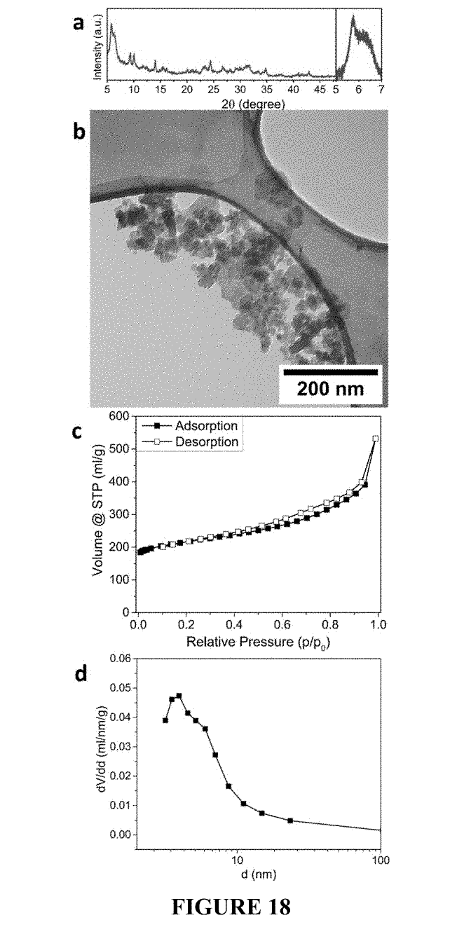

CG₆₀: The CG₆₀ took longer time to crystallize at 50° C., about 10 days. FIG. 18 shows the XRD, TEM, adsorption isotherms and pore size distributions. Of all the samples examined, this material has the largest amount of EMT (92%), and the smallest particle size (48 nm). It also has the largest external surface area (259 m²/g), along with a broad pore size distribution (2-30 nm).

Detailed Studies on CG₄₀ System

In order to gain more insight on the synthesis process, we investigated the CG₄₀-50C system in more detail.

Dynamics of Crystallization

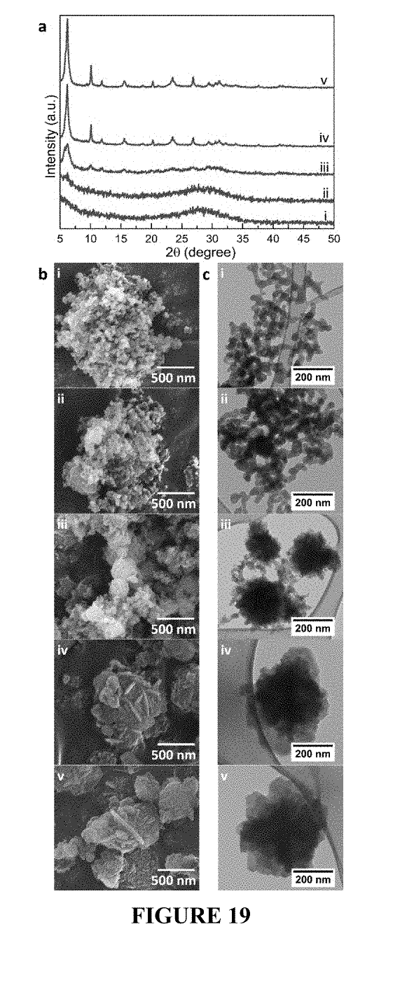

The evolution of crystals in the CG₄₀ system as it was aged at 50° C. was examined. The specific surface area and the external surface area of CG₄₀ increases continually with time (Table 3). In particular, Sₑₓₜ changes from 48 m²/g (CG₄₀-50C0d), 51 m²/g (CG₄₀-50C1d), 64 m²/g (CG₄₀-50C2d), 111 m²/g (CG₄₀-50C3d) and, 155 m²/g (CG₄₀-50C4d, 4 days). XRD indicates that CG starts to crystallize after 3 days, as shown in FIG. 19, panel a. Morphologies of CG₄₀ heated at 50° C. for 1 to 4 days were characterized with SEM (FIG. 9, panel b) and TEM (FIG. 9, panel c). From day 1 to day 3, loose coral-like structure shrinks into a core. Then, ˜50 nm thick FAU nanosheets start to extend out from the core from day 3 to day 4. The nanosheets at the outer surface have sharp edges.

TABLE 3
N₂ adsorption characteristics of CG₄₀-50C
samples as a function of time.

| | S_{BET} | S_{Ext} | V_{micro} |
|---|---|---|---|
| Sample | m²/g | m²/g | cm³/g |
| CG₄₀-50C0d | 48 | 48 | — |
| CG₄₀-50C1d | 51 | 51 | — |
| CG₄₀-50C2d | 64 | 64 | — |
| CG₄₀-50C3d | 301 | 111 | 0.08 |
| CG₄₀-50C4d | 581 | 155 | 0.17 |

Yield of CG₄₀-50C4d-100C was 35%, with 98% of the Al being incorporated into the final product. Si/Al ratios of CG₄₀-50C4d-100C was 1.43 (Table 4, from ²⁹SiSSNMR spectra), comparable to Si/Al of zeolite synthesized via conventional hydrothermal methods from the same composition.

TABLE 4
Si/Al ratio of zeolite samples.

| Sample | Si/Al |
|---|---|
| CG₄₀-25C72d-100C | 1.45 |
| CG₄₀-50C4d-100C | 1.43 |
| CG₄₀-75C3d-100C | 1.48 |
| CG₄₀-100C | 1.45 |
| CG₄₀-50C4d-100C-HY | 1.60 |
| RG-100C-HY | 1.50 |

High Resolution TEM

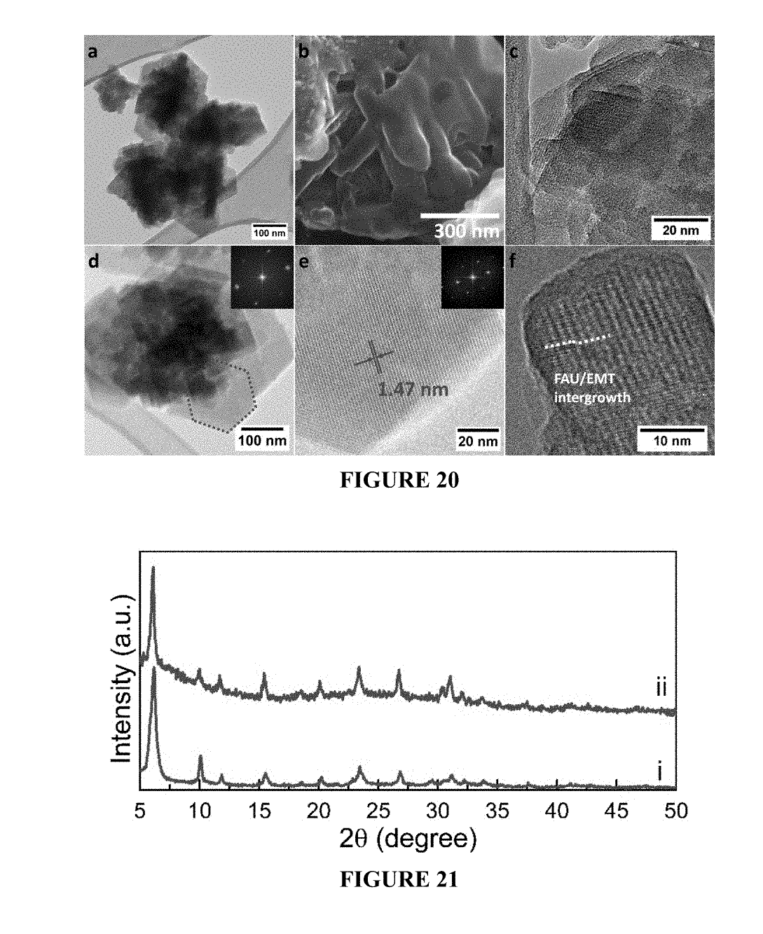

FIG. 20 shows the high-resolution TEM micrographs of CG₄₀-50C4d-100C. FIG. 20, panel a shows that the particles are about 400-500 nm in size. A FIB-SEM vertical cut through the particle results in FIG. 20, panel b, showing aggregates of nanosheets (there was some sample damage in FIB cutting process). FIG. 20, panel c, a higher resolution TEM image shows that the particle is made up of a collection of nanosheets. The larger nanosheets that extend out from the core appear fully crystalline, as evidenced by the TEM images in FIG. 20, panels d and e (insert shows discrete spots in Fast Fourier Transform (FFT) indicating single crystalline nature of each nanosheet). FIG. 20, panel f shows the presence of FAU-EMT intergrowths in the nanosheets.

Thermal/Hydrothermal Treatment

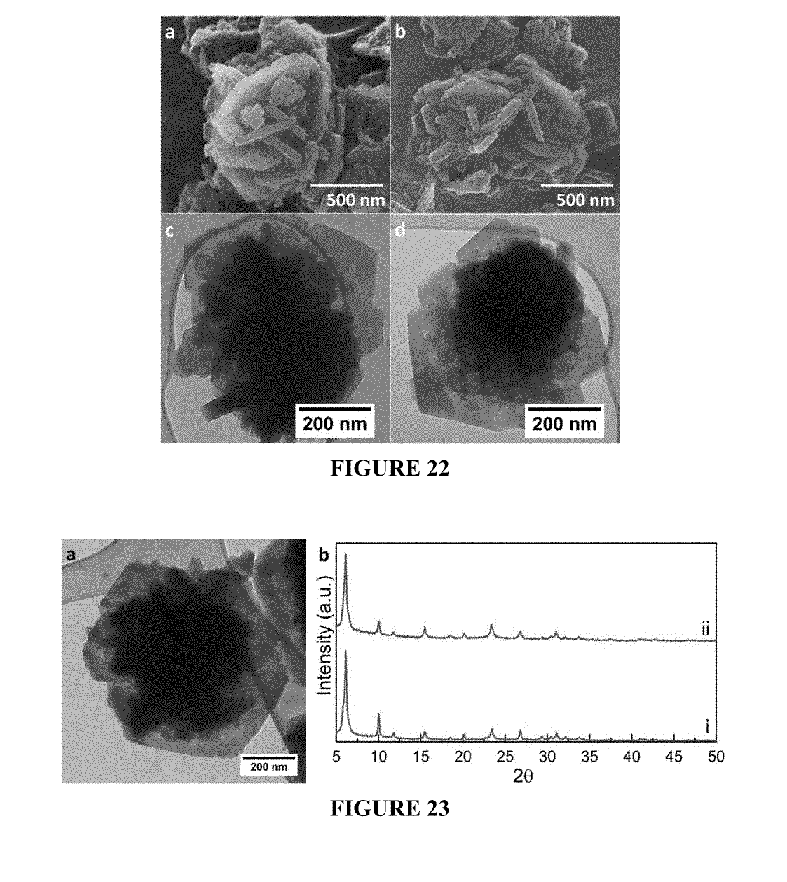

Morphology and crystallinity of CG₄₀-50C4d-100C after heat treatment at 600° C. for 24 hours was unchanged (XRD in FIG. 21, trace i), SEM and TEM images (FIG. 22), with a specific surface area of 834 m²/g and external surface area of 183 m²/g, indicating the thermal stability of the mesoporous structure. If the acidic form (NH₄⁺ exchanged) was heated at 550° C. in the presence of steam for 24 hours, there was considerable degradation, as evidenced in the XRD (FIG. 21, trace ii), and BET surface area of 346 m²/g and external surface area of 126 m²/g.

Catalysis Studies

The influence of the higher external surface area in CG₄₀-50C4d-100C on the dealkylation of 1,3,5-TIPB (9.5 Å, cannot penetrate the 7.4 Å zeolite pores) was compared with the microporous-only RG-100C sample. All samples used the acid forms of the zeolite, prepared via NH₄⁺ exchange and calcination, and carried out between 200-500° C. (without steam). Crystallinity and morphology of CG-50C4d-100C catalysts were maintained and confirmed by XRD patterns and TEM image in FIG. 23. Si/Al ratio of acidic CG-50C4d-100C and RG-100C are shown in Table 4. Table 5 details the product distributions.

TABLE 5
1,3,5-triisopropylbenzene dealkylation catalysis product distribution

| Sample | Temp. (° C.) | Benzene | Cumene | 1,3-DiPBz | 1,4-DiPBz | Other* | 1,3,5-TiPBz | Conversion (%) |
|---|---|---|---|---|---|---|---|---|
| CG₄₀- | 200 | 0.1% | 0.5% | 17.7% | 0.1% | 6.5% | 75.1% | 24.9% |
| 50 C. 4 d- | 300 | 1.0% | 3.2% | 38.0% | 0.1% | 15.1% | 42.6% | 57.4% |
| 100 C. | 400 | 0.5% | 4.9% | 58.6% | 1.2% | 30.0% | 4.8% | 95.2% |
| | 500 | 0.4% | 2.7% | 41.0% | 1.7% | 46.0% | 8.1% | 91.9% |
| RG- | 200 | 0.4% | 0.5% | 8.6% | 4.3% | 35.3% | 51.0% | 49.0% |
| 100 C. | 300 | 0.2% | 0.2% | 6.0% | 3.5% | 53.2% | 36.8% | 63.2% |
| | 400 | 0.3% | 0.4% | 6.5% | 4.8% | 55.4% | 32.4% | 67.6% |
| | 500 | 0.5% | 0.3% | 4.1% | 2.8% | 77.8% | 14.5% | 85.5% |

*Other includes propylene, coke and unrecognized products.

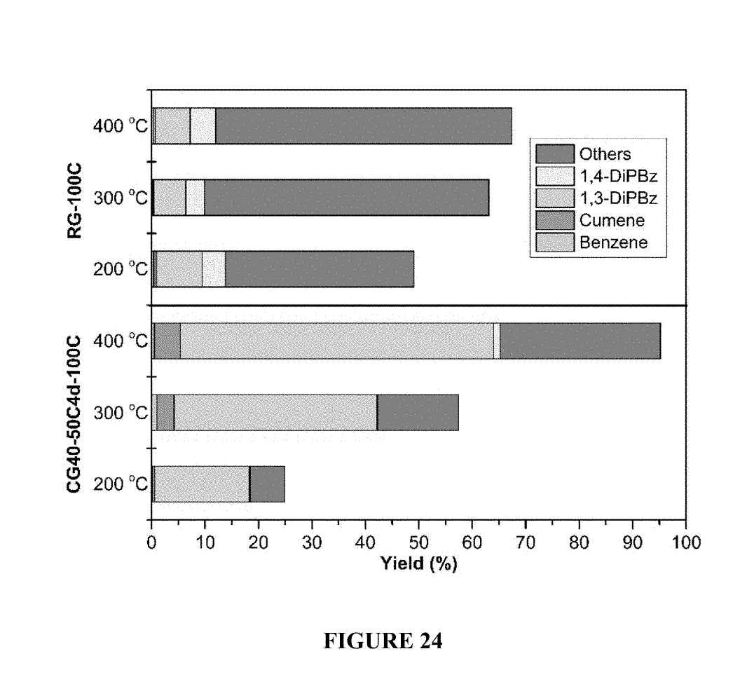

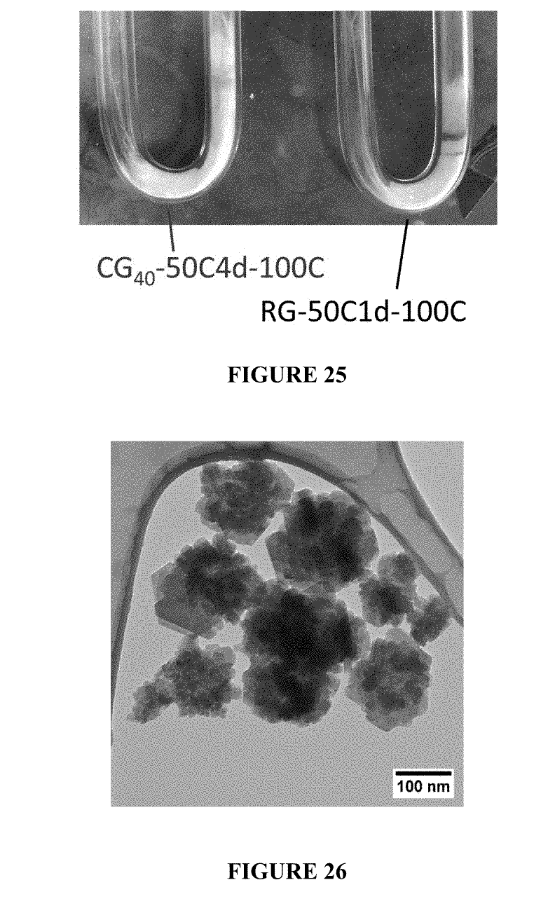

The products of the reaction at 200-400° C. are shown in FIG. 24, and the trends for each class of material were similar. The overall conversion of 1,3,5 TIPB at 400° C. were higher for CG₄₀-50C4d-100C (95%) as compared to RG-100C (68%), and the product distributions were very distinct with the two materials. For CG₄₀-50C4d-100C, dialkylated products, cumene and benzene is produced, whereas with RG-100C, there is much lower amounts of the dialkylated products, considerable isomerization of 1,3 to 1,4 TIPB, and coke is formed, as evidenced by the appearance of a brown catalyst after the reaction (FIG. 25).

### Discussion

Importantly, mesoporosity was generated during the synthesis of microporous zeolites described herein. This discussion focuses on the types of mesopores that develop, and the synthesis conditions that promote them.

The starting gel composition 8.3 Na₂O 1Al₂O₃ 6.4SiO₂ 483H₂O under typical hydrothermal conditions leads to well-defined microporous faujasitic zeolite with Si/Al=1.5. The treatment of this gel was modified as outlined in FIGS. 4 and 5. RG was the solid isolated after refluxing the gel for an hour at 100° C., and was still amorphous. CG was prepared by permanently removing a certain portion of the water from the gel via distillation, and our focus here is on 20, 40 and 60% removal of the water (CG₂₀, CG₄₀, CG₆₀, respectively). All three CG samples were amorphous, and we have studied the CG₄₀ in most detail. Even though CG₄₀ was amorphous by XRD, the electron micrograph (FIG. 6, panel b) shows bright spots. Such bright spots in the electron micrograph of an aluminosilicate gel has been related to trapped liquids in a study on EMT. Since such spots were not observed in the case of RG, it is possible that these bright spots are instead indicative of small crystalline regions (could not be imaged by TEM at high resolution because of beam damage). The process of removing the water results in concentration of the gel and promotes nucleation. Both RG and CG₄₀ when heated at 100° C. for 2h results in well crystallized FAU with no mesoporosity.

The CG₂₀ sample crystallizes at 50° C. within 4 days. Only FAU crystals were observed, with minimal mesoporosity, and not investigated any further. Mesoporosity developed in the CG₄₀ and CG₆₀ samples, the extent depending on the aging temperature and time (Table 1). The size distribution of the mesopores also was influenced by these factors. The other important observation was the appearance of EMT, along with FAU (Table 2). As described below, these observations are interrelated.

For the CG₄₀ samples, low temperatures promoted EMT, with the aging at 2° C. for 247 days leading to the maximum amount of EMT (16%). With CG₆₀, even though the gel was more concentrated, it took 10 days for crystallization at 50° C. (as compared to 4 days for CG₂₀ and CG₄₀) and led to formation of mostly EMT (92%). Both the CG₄₀-2C and the CG₆₀-50C samples also produce the smallest crystals (48, 51 nm, FIG. 16 panel a, FIG. 18, panel b, respectively), and the highest external surface area (249 and 259 m²/g, respectively). The nutrient transport during crystallization was slowed down either via decreasing temperature (CG₄₀-2C) or increasing gel viscosity (CG₆₀-50C). As the crystal growth is slowed down by limiting mass transport, there was higher amounts of EMT formed (Table 2).

Previous studies have noted that limiting mass transport influences the mesoporosity. Vapor phase synthesis of ZSM-5 from an aluminosilicate gel resulted in mesopores between the nanocrystals. Using a steam assisted conversion of a dense gel, 20 nm crystals of zeolite beta assembled to form a mesoporous structure. Steam assisted transformation of a silica gel to hierarchical silicalite has also been reported.

Here, the high Sₑₓₜ (>200 m²/g) observed for the CG₄₀-2C247d-100c and CG₆₀-50C10d-100c samples arise from the extensively nucleated nanocrystals in the gel that connect to form the mesoporosity. The pore size distribution of the mesopores was also broad (2-100 nm for CG₄₀-2C247d-100C and 2-30 nm for CG₆₀-50C10d-100C).

On the other hand, the CG₄₀-50C samples were quite distinct. The particle size was larger, between 200-500 nm, and each particle appears to be a collection of sheets with tens of nanometer thickness (FIG. 17). These nanosheets appear to be the result of FAU-EMT intergrowths (FIG. 20, panel f). With a Zn²⁺ and Li⁺ aluminosilicate gel, similar layer-like morphologies arising from FAU/EMT intergrowths have been observed. Materials generated with the use of Zn²⁺/Li⁺ in a completely inorganic composition are most similar to CG₄₀-50C4d-100C, though the latter tends to be smaller in size by an order of magnitude (<500 nm). The materials made with Zn²⁺/Li⁺ are also quite distinct in morphology from the nanosized CG₄₀₂C and CG₆₀50C. Zinc salts are known to promote twinning in MFI crystals, and Li⁺ also promotes twinning in EMT/ZSM-3 formation. In a clear sol sodium aluminosilicate composition, FAU/EMT intergrowths were observed, and lead to mesoporosity, and cryo-TEM shows the coexistence of these crystals at early times of synthesis.

In this case with only Na⁺ in a highly viscous gel composition, the mechanism was possibly different form the clear sol synthesis, since FAU was the preferred form with the present composition, and only by controlling kinetic aspects (slowing down the mass transport) was the formation of FAU/EMT intergrowths promoted.

The sheets in CG₄₀-50C4d-100C were about ˜50 nm in width and tightly bonded to each other to generate a single particle. This is obvious from the SEM of the FIB cut along a vertical cross-section of the particle (FIG. 20, panel b). In addition, these nanosheets are held together firmly and are not broken apart by sonication (see TEM image in FIG. 26). It is the packing and intergrowths of the nanosheets that generate the mesoporosity. The pore size distribution CG₄₀-50C4d-100C was considerably narrower (2-20 nm) as compared to the mesoporosity generated by the packing of nanoparticles in CG₄₀-2C and CG₆₀-50C samples (FIGS. 14, panel c; 14, panel a; and 18, panel d).

In all samples with mesoporosity, the micropore volume of 0.22-0.26 cm³/g was maintained, with a slight decrease in micropore volume for the smallest crystals. This decrease in micropore volume with size has also been noted for zeolite beta.

Though the thermal stability of CG₄₀-50C4d-100C sample was excellent, the hydrothermal stability of the acid form of the sample in the presence of steam was poor (though it was stable in the absence of steam). This is not surprising considering the Si/Al ratio is 1.5 for this sample. The surface area measurements indicate collapse of both the micropores and mesopores with high temperature steam (FIG. 21, Table 1).

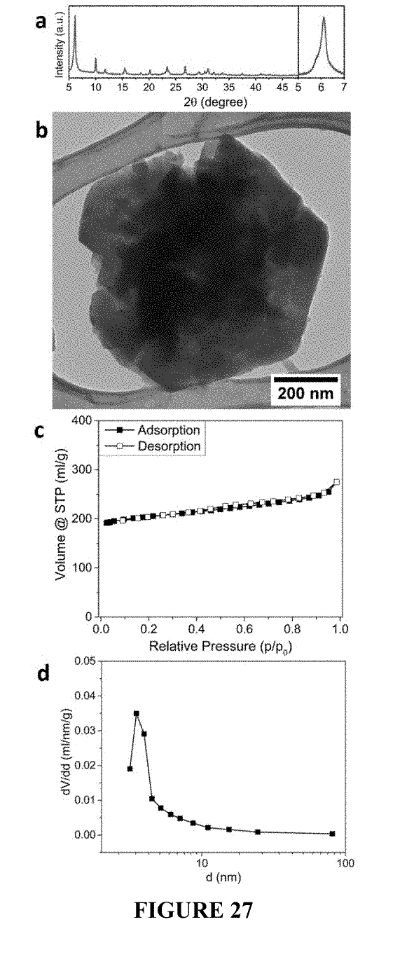

CG samples were prepared by distilling water out of the reaction mixture during reflux, and two control experiments provide mechanistic information. The first issue is the property of a gel composition that has water removed right from the start, and its comparison with CG₄₀. The following gel composition 8.3 Na₂O 1Al₂O₃ 6.4SiO₂ 290 H₂O was made, aged for 4 hours and then the gel was refluxed for an hour, followed by aging of the gel at 50° C. (labeled as CRG₄₀-50C4d-100C). With this material, the crystallization was complete in one day versus the four days it took for the identical CG₄₀-50C4d-100C composition to crystallize. The material was primarily FAU with minor EMT as measured by XRD (FIG. 27, panel a). From the TEM image (FIG. 27, panel b), it appears that the sheets were thicker (85 nm), the particle size was significantly larger (>600 nm, compare FIG. 27, panel b with FIG. 16, panel c), and the mesoporosity was lower (Sₑₓₜ=112 m²/g). This suggests that removal of the water during the reflux results in a different pathway as compared to a more concentrated gel right from the start, both of the same composition.

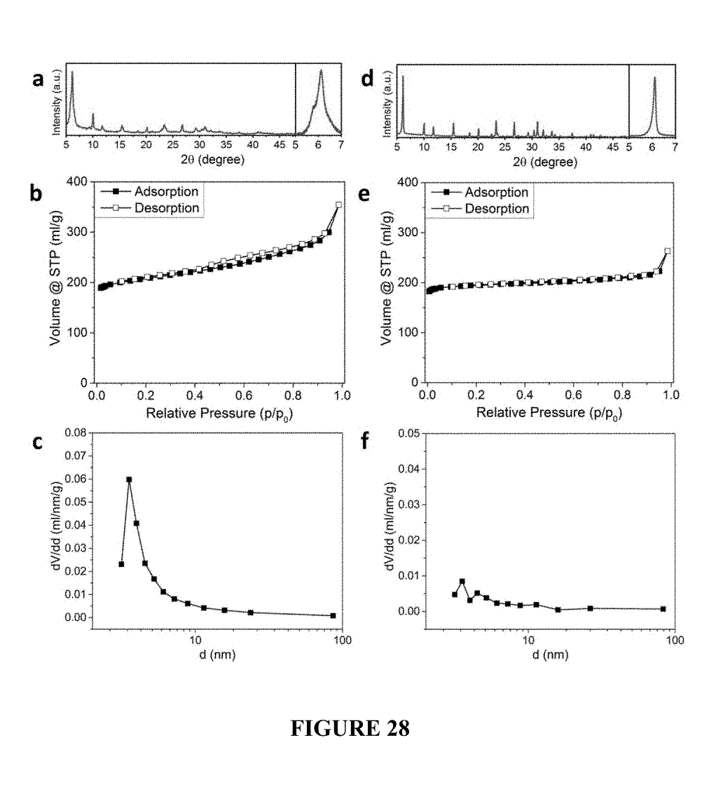

The second issue is the effect of the rate of water removal from the gel on the crystallization pathway. FIG. 28 (panels a, b, and c) show that removing 40% water in 30 min (as compared to 1 hour) results in more EMT (14%) with comparable external surface area (162 m²/g) and similar crystal growth dynamics to CG₄₀-50C4d-100C. Slower removal of the water (2 hr) results in rapid crystallization of FAU with no EMT and no mesoporosity (FIG. 28, panels d, e, and f). Faster removal of water results in a more viscous gel with lower mass transport that favors EMT. Slower removal also keeps the entire system under reflux conditions longer, directing the system to FAU.

Factors that change the composition mid-synthesis (freeze-drying or distillation) have different effects on the final products and their morphology. The advantage of removal of water by distillation is that it provides several routes of directing the crystallization process. These include the amount of water removed, as well as the rate of removal of the water, and the temperature of crystallization. These different routes result in materials with very distinct morphologies.

The mesoporosity of the CG₄₀-50C4d-100C sample leads to an altered chemical reactivity of 1,3,5-TIPB as compared to the microporous only sample RG-100C. Cracking of 1,3,5-TIPB has been extensively studied, and the major reaction pathway occurs via consecutive loss of propyl groups to form the dialkylated products, cumene, benzene and propylene, as well as coke. The conversions increased as a function of reaction temperatures for both CG₄₀-50C4d-100C and RG-100C samples, though the conversion level was higher for CG₄₀-50C4d-100C (e.g. at 400° C., the conversion for CG₄₀-50C4d-100C and RG-100C were 95 and 68% respectively, FIG. 24 and Table 5). Both CG₄₀-50C4d-100C and RG-100C should have comparable acidity (similar Si/Al ratio), thus the product distribution is a reflection of the textural properties. In CG₄₀-50C4d-100C, the mesopores provides the reaction site for the first dealkylation step of 1,3,5-TIPB, and the resulting 1,3 DIPB can react within the zeolite micropores to form cumene, and then benzene. With RG-100C, the reaction occurs on the zeolite surface and blocks the pores and results in coking of the sample (FIG. 25). As shown in this catalysis study, the presence of mesopores leads to a different reactivity in the CG₄₀-50C4d-100C, with comparable results to mesoporous zeolites formed by packing of nanocrystals. Because of the steam degradation shown in FIG. 21, these materials may in some cases be limited as acid cracking catalysts at high temperatures, but there are definitely possibilities for base catalysis, which are typically done under milder conditions, as has been documented for low Si/Al zeolites, such as zeolites A and X.

### CONCLUSION

Herein, a synthesis method that involves removal of water from an aluminosilicate gel of composition 8.3 Na₂O:1 Al₂O₃:6.4 SiO₂:483.9 H₂O during reflux is described. The amounts of water removed varied between 20-60% of the total volume. A CG₄₀50C4d100C sample is defined as removing 40% of the water, maintaining the resulting gel at 50° C. for 4 days, and then heating at 100° C. for two hours (all samples were subjected to the same 100° C. treatment, and typically resulted in slight improvement of surface area). Crystallization pathways of the resulting concentrated gels take various routes depending on the mass transport, which is controlled by temperature or gel viscosity (depending on how much water is removed). Resulting materials in all cases were microporous zeolite crystals with varying degrees of mesoporosity (external surface area ranging from 127-259 m²/g). Removing water while heating the initial gel enhances both supersaturation and promotes nucleation via the added thermal energy. The final morphology of the crystals was dependent on the viscosity of the gel and the temperature, which influence nutrient transport. The smallest crystallites (˜50 nm) were generated under the most constrained mass transport (e.g. CG₄₀-2C247d-100C and CG₆₀-50C10d-100C), and were more EMT rich. In these cases, the mesoporosity was produced via packing of the small crystallites, with a broad pore size distribution (2-100 nm). Another type of material as manifested in the sample CG₄₀-50C4d-100C had narrower mesopore distribution (2-20 nm), and formed by interpenetrating packing of nanosheets (which were FAU-EMT intergrowths). Cracking of 1,3,5-TIPB on the mesopore containing sample CG₄₀-50C4d-100C leads to higher conversion and dialkylated products, cumene and benzene whereas with the non-mesoporous FAU zeolite, significant levels of coke were formed.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and methods steps disclosed herein are specifically described, other combinations of the components and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method for synthesizing a hierarchically porous aluminosilicate material comprising:
(i) combining, in aqueous solution, a base, an aluminum source, and silicon source to form a precursor gel;
(ii) removing water from the precursor gel to form a nucleated gel; and
(iii) reacting the nucleated gel at a temperature of from 0° C. to 200° C. to form the hierarchically porous aluminosilicate material.

2. The method of claim 1, wherein step (i) comprises adding the silicon source to an aqueous solution comprising the base and the aluminum source

3. The method of claim 1, wherein step (i) further comprises aging the precursor gel.

4. The method of claim 3, wherein aging the precursor gel comprises incubating the precursor gel at room temperature for from one hour to two weeks.

5. The method of claim 1, wherein the molar ratio of sodium:aluminum in the precursor gel is from 2 to 15.

6. The method of claim 1, wherein the molar ratio of water:aluminum in the precursor gel is from 200 to 1000.

7. The method of claim 1, wherein step (ii) comprises removing an effective amount of water to induce nucleation, as determined by electron microscopy.

8. The method of claim 7, wherein step (ii) comprises reducing the volume of the precursor gel by at least 50%.

9. The method of claim 8, wherein step (ii) comprises reduces the volume of the precursor gel by at least 50% in one hour or less.

10. The method of claim 1, wherein step (iii) comprises reacting the nucleated gel for a period of time effective for the hierarchically porous aluminosilicate material to exhibit a crystalline morphology, as determined by powder x-ray diffraction.

11. The method of claim 1, wherein reacting the nucleated gel comprises heating the nucleated gel at a temperature of from 25° C. to 200° C.

12. The method of claim 1, wherein the hierarchically porous aluminosilicate material comprises a zeolite, and wherein the zeolite comprises faujasite, EMT, or a mixture thereof.

13. The method of claim 1, wherein the precursor gel comprises 8-8.5Na₂O:0.8-1.2Al₂O₃:6-7SiO₂:400-600H₂O.

14. The method of claim 1, wherein the hierarchically porous aluminosilicate material exhibits a silicon:aluminum ratio of from 1 to 5.

15. The method of claim 14, further comprising processing the hierarchically porous aluminosilicate material to increase the silicon:aluminum ratio to 5 or more.

16. The method of claim 1, wherein the hierarchically porous aluminosilicate material is substantially free of zinc.

17. The method of claim 1, wherein the hierarchically porous aluminosilicate material is substantially free of lithium.

18. The method of claim 1, wherein the hierarchically porous aluminosilicate material is substantially free of organic compounds.

19. A hierarchically porous aluminosilicate material prepared by a process comprising:
(i) combining, in aqueous solution, a base, an aluminum source, and silicon source to form a precursor gel;
(ii) removing water from the precursor gel to form a nucleated gel; and
(iii) reacting the nucleated gel at a temperature of from 0° C. to 200° C. to form the hierarchically porous aluminosilicate material.

20. A hierarchically porous aluminosilicate material comprising aluminum, silicon, and sodium ions;
wherein, the molar ratio of sodium ions:aluminum is from 2 to 10 and the molar ratio of silicon:aluminum is from 2 to 15;
wherein the hierarchically porous aluminosilicate material has a ratio of total volume to micropore volume of at least 1.5;
wherein the hierarchically porous aluminosilicate material exhibits an external surface area of from 50 m²/g to 300 m²/g.
